(19) United States
(12) Patent Application Publication
(10) Pub. No.: US 2026/0323053 A1
(43) Pub. Date: Oct. 15, 2026

(54) METHODS AND APPARATUS FOR DYNAMIC TRANSCODING BASED ON VIDEO COMPLEXITY

(71) Applicant: GoPro, Inc., San Mateo, CA (US)

(72) Inventors: Cedric Fernandes, San Ramon, CA (US); Jean-Marc Thiesse, Paris (FR); Maxime Bichon, Paris (FR)

(73) Assignee: GoPro, Inc., San Mateo, CA (US)

(21) Appl. No.: 19/175,309

(22) Filed: Apr. 10, 2025

(51) Int. Cl. H04N 19/40; H04N 19/127; H04N 19/14; H04N 19/196

(52) U.S. Cl. CPC H04N 19/40; H04N 19/127; H04N 19/14; H04N 19/196

(57) ABSTRACT

Systems, apparatus, and methods for dynamic transcoding based on video complexity. Transcoding inherits many of the same design assumptions as conventional video encoding which is optimized for content delivery networks that encode-once-deliver-often. Consumer grade encoders often transcode media on an as-needed basis since they lack the processing capability and/or volume of decodes to defray the cost of expensive encoding in advance. This typically occurs downstream from the camera and may be performed by different devices, with different parameters, to suit a variety of different usages. Codec optimization strategy mismatches are likely to occur in consumer ecosystems that combine different devices with competing design criteria. Dynamic transcoding based on previous codec information can improve the performance and/or capabilities of post-processing environments. Disclosed solutions dynamically adapt transcoding parameters (e.g., target bitrate, etc.) by leveraging complexity analysis from previous stages (capture, encoding, transcoding, etc.).

### RELATED APPLICATIONS

This application is related to U.S. application Ser. No. 18/701,256, filed Apr. 15, 2024, and entitled “METHODS AND APPARATUS FOR REAL-TIME GUIDED ENCODING”, and U.S. application Ser. No. 18/423,533, filed Jan. 26, 2024, and entitled “METHODS AND APPARATUS FOR DYNAMIC CODEC CONFIGURATION”, incorporated herein by reference in their entireties.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates to transcoding video content. Specifically, the present disclosure relates to transcoding video content characterized by dynamically changing complexity.

### DESCRIPTION OF RELATED TECHNOLOGY

Existing video encoding techniques utilize so-called intra-frames (I-frames), predicted frames (P-frames), and bi-directional frames (B-frames). The 3 different frame types may be used in specific situations to improve video compression efficiency. Most codecs encode video based on image analysis and metrics. Image analysis is computationally complex and often requires look-forward/look-backward comparisons between frames.

An embedded device is a computing device that contains a special-purpose compute system. In many cases, embedded devices must operate within aggressive processing and/or memory constraints to ensure that real-time budgets are met. For example, an action camera (such as the GoPro HERO™ families of devices) must capture each frame of video at the specific rate of capture (e.g., 30 frames per second (fps)). As a practical matter, video compression quality may be significantly limited in embedded devices.

### BRIEF DESCRIPTION OF THE DRAWINGS

FIG. 1 depicts a logical flow diagram of the image processing pipeline (IPP), useful for explaining various aspects of the present disclosure.

FIG. 2 depicts a graphical representation of image quality as a function of bitrate for encoding an image of fixed resolution and an ideal convex hull, useful for explaining various aspects of the present disclosure.

FIG. 3 depicts a graphical representation of the range of possible bitrates for a target quality, useful for explaining various aspects of the present disclosure.

FIG. 4, depicts a graphical representation of dynamic encoding data structures within a mobile ecosystem, in accordance with various aspects of the present disclosure.

FIG. 5 depicts illustrative plots for an “iso-quality” bitrate encoding, in accordance with various aspects of the present disclosure.

FIG. 6 depicts a graphical representation of one single-pass iso-quality encoding process, in accordance with various aspects of the present disclosure.

FIG. 7 depicts a logical block diagram of dynamic encoder control logic which dynamically generates encoder configurations to re-map/translate between encoder configurations

FIG. 8 depicts a logical block diagram of a transcoding cascade which cumulatively updates dynamic media data structures that correspond to transcoded bitstream outputs.

FIG. 9 depicts a logical block diagram of the system, in accordance with various aspects of the present disclosure.

FIG. 10 depicts a logical block diagram of a capture device, in accordance with various aspects of the present disclosure.

FIG. 11 depicts a logical block diagram of a post-capture device, in accordance with various aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Image Processing Pipeline

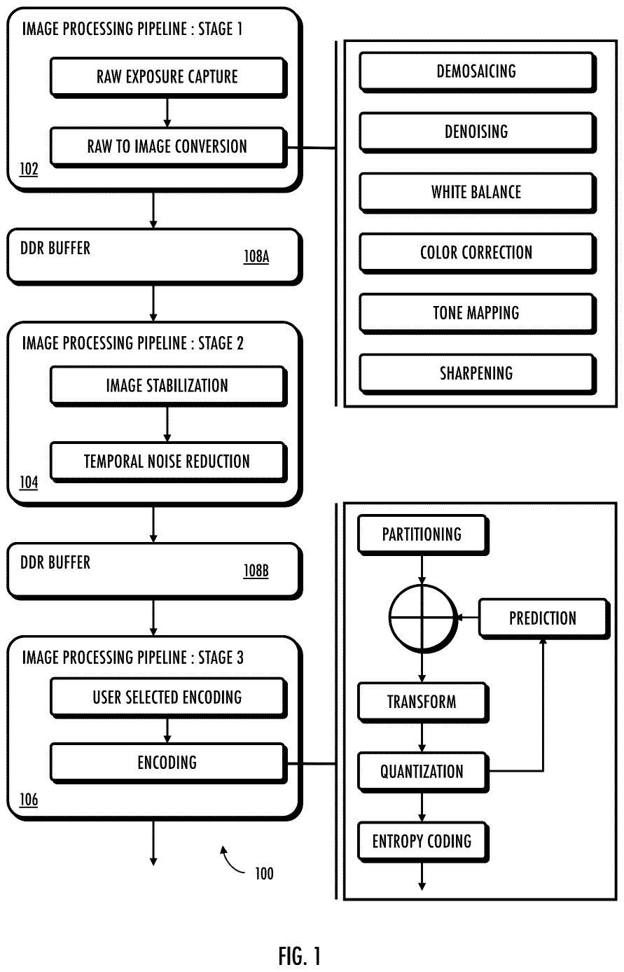

FIG. 1 is a logical flow diagram of an image processing pipeline (IPP) 100, useful to illustrate various aspects of the present disclosure. As shown, the IPP has three (3) stages: a first stage 102 that captures raw data and converts the raw data to a color space (e.g., YUV), a second stage 104 that performs in-camera pre-processing, and a third stage 106 for encoding video. Transitions between stages of the pipeline are facilitated by DDR buffers 108A, 108B.

As a brief aside, the first stage 102 converts “raw” light information that was captured by a sensor, into “pixel” data that is suitable for display and/or post-capture image manipulations (post-processing). Typically, ISP operations include demosaicing, white balance, denoising, color correction, tone mapping, sharpening, etc. While the following discussion is presented with a specific set of operations and ordering, other operations and/or orders may be substituted with equal success.

Here, the first stage 102 is implemented within an image signal processor (ISP). As shown, the ISP controls the light capture of a camera sensor and may also perform color space conversion. The camera captures light information by “exposing” its photoelectric sensors for a short period of time. The “exposure” may be characterized by three parameters: aperture, ISO (sensor gain) and shutter speed (exposure time). Exposure determines how light or dark an image will appear when it's been captured by the camera. During normal operation, a digital camera may automatically adjust aperture, ISO, and shutter speed to control the amount of light that is received; this functionality is commonly referred to as “auto exposure”. Most action cameras are fixed aperture cameras due to form factor limitations and their most common use cases (varied lighting conditions)—fixed aperture cameras only adjust ISO and shutter speed.

After each exposure, the ISP reads raw luminance data from the photoelectric camera sensor; the luminance data is associated with locations of a color filter array (CFA) to create a “mosaic” of chrominance values. The ISP demosaics the luminance and chrominance data to generate a standard color space for the image; for example, in the illustrated embodiment, the raw data is converted to the YUV (or YCrCb) color space.

The ISP performs white balance and color correction to compensate for lighting differences. White balance attempts to mimic the human perception of “white” under different light conditions. As a brief aside, a camera captures chrominance information differently than the eye does. The human visual system perceives light with three different types of “cone” cells with peaks of spectral sensitivity at short (“blue”, 420 nm-440 nm), middle (“green”, 530 nm-540 nm), and long (“red”, 560 nm-580 nm) wavelengths. Human sensitivity to red, blue, and green change over different lighting conditions; in low light conditions, the human eye has reduced sensitivity to red light but retains blue/green sensitivity, in bright conditions, the human eye has full color vision. Without proper white balance, environmental color temperatures will look unnatural. For instance, an image shot in a fluorescent room will look “greenish”, indoor tungsten light will look “yellowish”, and shadows may be “bluish”. White balance can correct the “white point”, however additional color correction may be necessary to balance the rest of the color spectrum. Color correction may mimic natural lighting, or add artistic effects (e.g., to make blues and oranges “pop”, etc.).

After color space conversion, the output images of the first stage 102 of the IPP may be written to the DDR buffer 108A. In one specific implementation, the DDR buffer 108A may be a first-in-first-out (FIFO) buffer of sufficient size for the maximum IPP throughput; e.g., a 5.3K (15.8 MegaPixels) of 10-bit image data at 60 frames per second (fps) with a 1 second buffer would need ~10 Gbit (or 1.2 GByte) of working memory. In some cases, the memory buffer may be allocated from a system memory; for example, a 10 Gbit region from a 32 Gbit DRAM may be used to provide the DDR buffer 108A. In the illustrated embodiment, the memory buffers can be accessed with double-data rate (DDR) for peak data rates, but should use single data rate (SDR), when possible, to minimize power consumption and improve battery life. While the illustrated embodiment depicts two memory buffers for clarity, any number of physical memory buffers may be virtually subdivided or combined for use with equal success.

Auto exposure and color space conversion statistics may be written as metadata associated with the output images. As but one such example, auto exposure settings (ISO, and shutter speed) for each image may be stored within a metadata track. Similarly, white balance and color correction adjustments may be stored within the metadata track. In some cases, additional statistics may be provided—for example, color correction may indicate “signature” spectrums (e.g., flesh tones for face detection, spectral distributions associated with common sceneries (foliage, snow, water, cement), and/or specific regions of interest. In fact, some ISPs explicitly provide e.g., facial detection, scene classification, and/or region-of-interest (ROI) detection.

Artisans of ordinary skill in the related art will readily appreciate that the first stage 102 of the IPP may include other functionality, the foregoing being purely illustrative. As but one example, some ISPs may additionally spatially denoise each image before writing to DDR buffer 108A. As used herein, “spatial denoising” refers to noise reduction techniques that are applied to regions of an image. Spatial denoising generally corrects chrominance noise (color fluctuations) and luminance noise (light/dark fluctuations). Other examples of ISP functionality may include, without limitation, autofocus, image sharpening, contrast enhancement, tone mapping, and any other sensor management/image enhancement techniques.

Referring back to FIG. 1, the second stage 104 is implemented within a central processing unit (CPU) and/or graphics processing unit (GPU). The second stage 104 retrieves groups of images from the DDR buffer 108A and incorporates sensor data to perform image stabilization and other temporal denoising. As used herein, “temporal denoising” refers to noise reduction techniques that are applied to across multiple images.

As a brief aside, action photography is captured under difficult conditions which are often out of the photographer's control. For example, action cameras are often used while in-motion. As a result, the relative motion between the camera's motion and the subject motion can create the perception of apparent motion when the footage is subsequently viewed in a stable frame-of-reference. In-device image stabilization may have significant benefits for downstream processing; for example, video codecs compress similar frames of video using motion estimation between frames, stabilized video results in much better compression (e.g., smaller file sizes, less quantization error, etc.)

A variety of different stabilization techniques exist to remove undesirable camera motion. For example, so-called electronic image stabilization (EIS) relies on image manipulation techniques to compensate for camera motion. As used herein, a “captured view” refers to the total image data that is available for electronic image stabilization (EIS) manipulation. A “designated view” of an image is the visual portion of the image that may be presented on a display and/or used to generate frames of video content. EIS algorithms generate a designated view to create the illusion of stability; the designated view corresponds to a “stabilized” portion of the captured view. In some cases, the designated view may also be referred to as a “cut-out” of the image, a “cropped portion” of the image, or a “punch-out” of the image.

Images captured with sensors that use an Electronic Rolling Shutter (ERS) can also introduce undesirable rolling shutter artifacts where there is significant movement in either the camera or the subject. ERS exposes rows of pixels to light at slightly different times during the image capture. As a brief aside, CMOS image sensors use two pointers to clear and write to each pixel value. An erase pointer discharges the photosensitive cell (or rows/columns/arrays of cells) of the sensor to erase it; a readout pointer then follows the erase pointer to read the contents of the photosensitive cell/pixel. The capture time is the time delay in between the erase and readout pointers. Each photosensitive cell/pixel accumulates the light for the same exposure time but they are not erased/read at the same time since the pointers scan through the rows. This slight temporal shift between the start of each row may result in a deformed image if the image capture device (or subject) moves.

ERS compensation may be performed to correct for rolling shutter artifacts from camera motion. In one specific implementation, the capture device determines the changes in orientation of the sensor at the pixel acquisition time to correct the input image deformities associated with the motion of the image capture device. Specifically, the changes in orientation between different captured pixels can be compensated by warping, shifting, shrinking, stretching, etc. the captured pixels to compensate for the camera's motion.

In some cases, temporal noise reduction may be used to further enhance the overall quality of the video content by reducing the visual artifacts or distortions caused by temporal variations. This can include random noise, flickering, or other irregularities that may be present in consecutive frames of a video or images. Temporal denoising techniques smooth differences in pixel movements between successive images. This technique may be parameterized according to a temporal filter radius and a temporal filter threshold. The temporal filter radius determines the number of consecutive frames used for temporal filtration. Higher values of this setting lead to more aggressive (and slower) temporal filtration, whereas lower values lead to less aggressive (and faster) filtration. The temporal filter threshold setting determines how sensitive the filter is to pixel changes in consecutive frames. Higher values of this setting lead to more aggressive filtration with less attention to temporal changes (lower motion sensitivity). Lower values lead to less aggressive filtration with more attention to temporal changes and better preservation of moving details (higher motion sensitivity). Temporal denoising may include calculations of pixel motion vectors between images for smoothing; these calculations are similar in effect to the motion vector calculations performed by the codec and may predict subsequent codec workload.

Referring back to FIG. 1, the image processing pipeline includes a third stage 106. The third stage 106 encodes a sequence of images into video formats for transmission, storage, and/or rendering. Complementary decoding operations can be used to decode the sequence of images from the video formats. Depending on the encoding techniques, the encoding may be lossy or lossless (the decoded images may, or may not, be exact reproductions of the original input images). “Lossless” operations preserve the original digital data fidelity, whereas “lossy” operations permanently remove data-once lost, the original data may not be recovered.

Here, the encoder is implemented within a codec that is configured via application programming interface (API) calls from the CPU. Codec operation may be succinctly condensed into the following steps: opening an encoding session, determining encoder attributes, determining an encoding configuration, initializing the hardware pipeline, allocating input/output (I/O) resources, encoding one or more frames of video, writing the output bitstream, and closing the encoding session. In slightly more detail, an encoding session is “opened” via an API call to the codec (physical hardware or virtualized software). The API allows the codec to determine its attributes (e.g., encoder globally unique identifier (GUID), profile GUID, and hardware supported capabilities) and its encoding configuration. In some implementations, the encoding configuration is based on real-time guidance (e.g., quantization, compression, bit rate adjustment, and/or group of picture (GOP) sizing may be based on parameters provided from upstream IPP operations). Thereafter, the codec can initialize its parameters based on its attributes and encoding configuration and allocate the appropriate I/O resources—at this point, the codec is ready to encode data. Subsequent codec operation retrieves input frames, encodes the frames into an output bitstream, and writes the output bitstream to a data structure for storage/transfer. After the encoding has terminated, the encoding session can be “closed” to return codec resources back to the system.

Real-time guidance can update and/or correct the encoding configuration during and (in some variants) throughout a live capture. Specifically, the third stage 106 of the IPP can use capture and conversion statistics (from the first stage 102) and sensed motion data (from the second stage 104) to configure the encoding parameters prior to processing. For instance, the CPU may determine quantization parameters based on auto exposure and color space conversion statistics for the output images discussed above. In some cases, quantization parameters may be based on pixel motion vectors obtained from the temporal denoising discussed above. Where available, facial recognition, scene classification, and/or region-of-interest (ROI) metadata may also be used. Additionally, flagged images and/or orientation information may be used to determine GOP sizing. Similar adjustments may be made to compression and bit rate adjustments. The real-time guidance information from previous stages may be retrieved in advance of encoding—this is a function of the IPP's pipelining. More directly, instead of buffering 1 second of images within the codec so that the codec can perform look-forward/look-behind prediction, the CPU can configure the codec's encoding parameters based on 1 second of real-time guidance provided by earlier stages of the IPP.

A comprehensive listing of various encoding parameters and API calls may be found at the following links (last retrieved Feb. 3, 2022), incorporated herein by reference in their entireties:
https://ffmpeg.org/doxygen/3.3/group_ENCODER_STRUCTURE.html;
https://ffmpeg.org/doxygen/3.3/structNV_ENC_PIC_PARAMS.html; and
https://ffmpeg.org/doxygen/3.3/structNV_ENC_CONFIG.html.

During encoding operation, the codec: partitions, predicts, transforms, quantizes, and entropy encodes, according to the aforementioned encoding parameters. While the following discussion is presented with a specific set of operations and ordering, other operations and/or orders may be substituted with equal success.

Partitioning temporally divides the input images into temporal blocks that are called groups of pictures (GOPs). Each GOP contains several frames. Depending on the parameterization of the encoder, each frame may be assigned a frame type: intra-coded (I) frames, predicted (P) frames, bidirectional predicted (B) frames. The GOP structure defines how the frame types are distributed; each GOP starts with an I-frame followed by several P-frames and/or B-frames. Each frame may be further spatially divided into blocks, and in some cases, sub-blocks.

Prediction is performed based on frame type. Intra-prediction uses only blocks from the same frame, inter-prediction uses blocks from other frames. I-frames only use intra-prediction. P-frames may only use inter-prediction from previous frames; B-frames may use inter-prediction from both previous frames and future frames. P-frames and B-frames may also use intra-prediction.

Typically, intra-prediction occurs in raster-scan ordering (e.g., right-to-left, top-to-bottom); a block is predicted based on the horizontal line of pixels immediately above it or the vertical line immediately to its left. The encoder chooses the best option from a list of possible predictions, such as taking the average of these pixels, or copying the line above it horizontally, or the line to the left vertically, etc. In contrast, inter-prediction uses motion estimation (ME) between two frames (e.g., previous and current, current and future, etc.) to estimate a motion vector (MV) for motion-compensated prediction MCP). The MV may be coarsely approximated initially, and then further refined with a localized search.

Prediction is seldom perfect, thus, the error between the predictions and the actual pixel values is commonly referred to as the “residual”. Different prediction modes may be selected based on the amount of residual and the motion vectors between frames. Under an “inter” mode, the pixel residual and MV approximation refinements are transmitted. Inter mode is efficient when there is overall movement in many directions everywhere (e.g., no common motion vector). “Merge” mode transmits the pixel residual and only the coarse MV approximations (no refinements); merge mode is efficient when there is stable and constant movement across frames. “Skip” mode does not transmit residuals or MV approximations; skip mode is efficient where there is very little motion between frames.

Ideally, the prediction residual is expected to contain mostly zeros and low values. The transform step converts the prediction residual to the frequency domain, which groups low spatial frequency information within only a few coefficients. In most video coding implementations, the transform is applied to the residual of a prediction instead of the image values themselves (image coding transforms usually are applied to the image values). The most common transforms are the Discrete Cosine Transform (DCT) and the Discrete Sine Transform (DST); some encoders may actively select between different transforms.

The foregoing steps may be implemented losslessly, however in some cases, some amount of lossy-ness is tolerable. In such implementations, the quantization step can be used to quantize the residuals, etc. to reduce data size. The quantization parameter (QP) is used to affect the amount of quantization; larger QP results in higher quantization and lossiness, lower QP results in lower quantization and preserves more fidelity. The QP is a key parameter of encoder operation and strongly influences the encoded image quality and size.

Entropy coding translates the encoder's data and quantized transformed residuals into a bitstream that is packaged into a container file. In some cases, entropy coding may additionally incorporate lossless encodings to improve compression.

Additional discussion about image processing pipelines, various modifications and improvements may be found in PCT Application Serial No. PCT/US23/62157, filed Feb. 7, 2023, and entitled “Methods and Apparatus for Real-Time Guided Encoding”, incorporated herein by reference in its entirety.

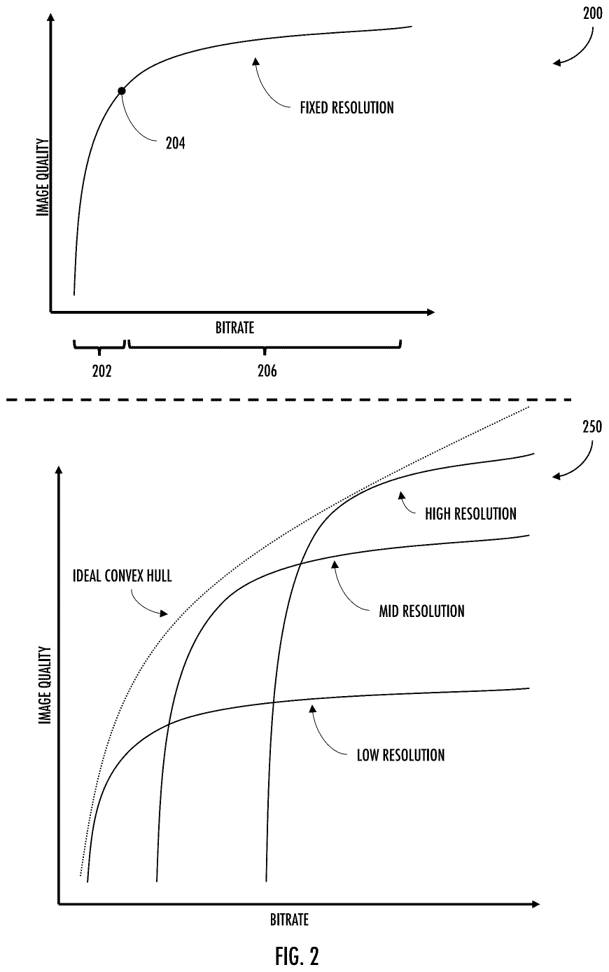

Dynamic encoding techniques seek to optimize the encoding process for an optimization target. Optimization techniques generally seek to balance multiple constraints; for example, a dynamic encoding technique might attempt to trade-off between bitrate, quality, and computational complexity, etc. Most trade-offs have some form of diminishing return. For example, a first bitrate-quality curve 200 of FIG. 2 illustrates how image quality varies as a function of bitrate for encoding an image of fixed resolution. The first bitrate-quality curve 200 is characterized by a region of steep ascent 202, a kink 204, and a plateau region 206. As shown, larger increases in bitrate are needed to achieve smaller increases in image quality in the plateau region 206.

FIG. 2 also compares multiple bitrate-quality curves 250 for different resolutions (scaled for comparison). At lower bitrates, low resolution encodings have an edge since fewer pixels are encoded. As the bitrate increases, however, the low resolution curve quickly reaches a natural limit of fidelity. Higher resolutions are harder to encode at low bitrates, but the number of bits eventually becomes enough to encode higher quantities of pixels resulting in a higher image quality (when compared to upscaled lower resolutions).

The observed relationship between bitrates, image quality, and resolution has been experimentally explored by others. For example, Per-title Encode Optimization published Dec. 14, 2015 by Aaron et al. at https://netflixtechblog.com/per-title-encode-optimization-7e99442b62a2, last retrieved Dec. 29, 2023 (hereinafter “Aaron”), incorporated herein by reference in its entirety, observes that “each resolution has a bitrate region in which it outperforms other resolutions”. Combining these points describes a “convex hull” that identifies the point of diminishing returns (kink) for all bitrate-resolution combinations. Aaron uses the convex hull to search for practical bitrate-resolution pairs that provides acceptable performance. Aaron is representative of most conventional dynamic encoding works. Table 1 provides a brief summary of other notable works in this area.

TABLE 1
Notable Dynamic Encoding Implementations

| Notable Implem.: | Application: | Optimization Target: | Technique: |
|---|---|---|---|
| Netflix (Aaron | VOD | Bitrate-Resolution | Exhaustive |
| et al.) | | Pairs | Search |
| Athena Lab | Live, VOD | Bitrate-Resolution | ML Prediction |
| | | Pairs | |
| INSA Rennes | Live, VOD | Bitrate-Resolution | ML Prediction |
| | | Pairs | |
| Bhat et al. | Live | Resolution | ML Prediction |

Most research into encoding techniques have been focused on dynamically encoding video for bandwidth and/or playback considerations. For example, VOD services are often limited to a few commonly supported resolutions (1080p, 4K, etc.) and must fit their services within available network capacity (bitrates). Live streaming is similarly constrained. Practical solutions for these applications generally focus on fixed “ladders” of bitrate-resolution pairs. Table 2 provides an example of a bitrate-resolution ladder described by Aaron.

TABLE 2
Notable Dynamic Encoding Implementations

| Bitrate (kbps) | Resolution |
|---|---|
| 235 | 320 × 240 |
| 375 | 384 × 288 |
| 560 | 512 × 384 |
| 750 | 512 × 384 |
| 1050 | 640 × 480 |
| 1750 | 720 × 480 |
| 2350 | 1280 × 720 |
| 3000 | 1270 × 720 |
| 4300 | 1920 × 1080 |
| 5800 | 1920 × 1080 |

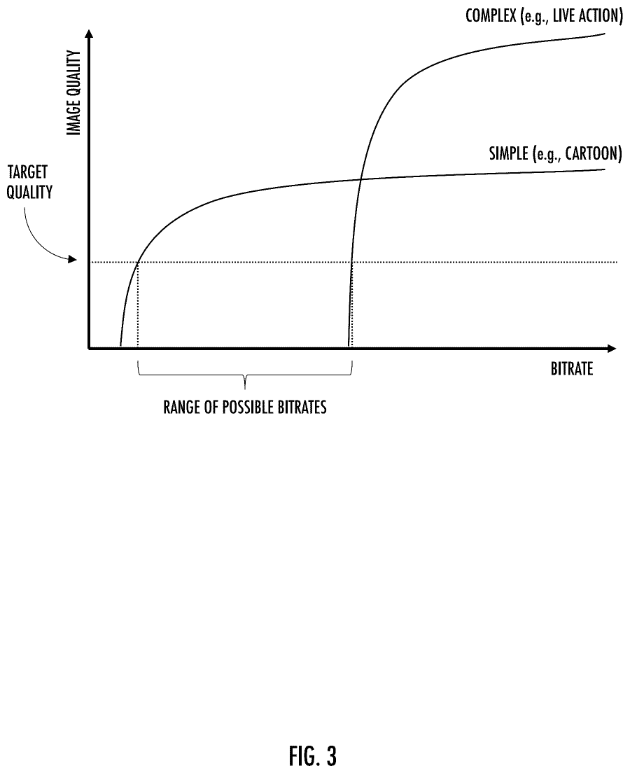

Importantly, these ladders are applied to all videos, regardless of their content. Although they are chosen to produce good encodings for most generic content, they are not individually selected for specific content (titles). An interesting example is live-action content versus animation content. Due to the simple nature of cartoons, sufficient quality can be achieved at lower bitrates, even for high resolutions. On the other hand, complex textures and movement in live-action demand more bits in their encodings. This effect is illustrated in FIG. 3. with the rate-quality curves of videos of different complexity but encoded with the same encoder configuration. Conceptually, this is because the actual resolution of the physical display (“display resolution”) is different than the resolution required to render perceptually acceptable content. VOD and live streaming applications take the practical approach of addressing known constraints (e.g., available network bandwidth and display resolution), which is easier task than trying to ascertain what might be “perceptually acceptable” for each title.

### Exemplary Transcoding Pipeline

GoPro, Inc. is a camera manufacturer that specializes in action camera photography. Action cameras have unique application requirements that are different than other cameras and/or media services. For example, most cameras record videos at a fixed bit rate to ensure fixed quality image capture; this assumes that the subject is relatively predictable and framed for capture. In contrast, dynamic encoding may be particularly useful for certain types of action photography (e.g., irregular/unpredictable subject (and/or camera) motion, long shooting sessions in unforgiving and unpredictable environments, etc.). Dynamic encoder configuration may be used to adjust a variety of different operational parameters to e.g., improve memory usage, reduce encoding complexity, prolong battery life, reduce temperature, etc. Dynamic encoding techniques are discussed in greater detail within U.S. application Ser. No. 18/701,256, filed Apr. 15, 2024, and entitled “METHODS AND APPARATUS FOR REAL-TIME GUIDED ENCODING”, and U.S. application Ser. No. 18/423,533, filed Jan. 26, 2024, and entitled “METHODS AND APPARATUS FOR DYNAMIC CODEC CONFIGURATION”, each of the foregoing previously incorporated by reference in their entireties.

Action cameras record video that is often “post-capture processed” (or more commonly “post-processed”). Here, “post-capture processing”, “post-processing”, and their linguistic derivatives refers to systems, processes, and/or devices that obtain previously captured media and apply one or more effects afterwards. Post-processing may impart aesthetic effects (“filters”) and/or prepare media for specific uses. Post-processing is widely employed in various industries, including filmmaking, broadcasting, gaming, etc.

Post-processing often includes transcoding. Here, “transcoding” and its linguistic derivatives refers to the process of converting media from a first encoding to a second encoding. Transcoding may be used to e.g., convert between different formats, adjust media characteristics (e.g., bitrate, resolution, group of picture (GOP) structure, etc.), modify media for application specific constraints (e.g., streaming, end device playback, archival, etc.), etc.

Since transcoding often leverages existing decoding and encoding technologies, it inherits many of the same design assumptions as conventional video encoding which is optimized for content delivery networks that encode-once-deliver-often. For example, conventional encoders (and their transcoding derivatives) often assume an unconstrained ability to look-forward or look-backward in the video to maximize compression and video quality. In many cases, such encoders improve compression performance by increasing the search space-both in the number of frames held in memory as well as in-frame pixel searches for motion estimation. These techniques are often performed at “best-effort” with unconstrained processing power and memory.

Furthermore, consumer grade encoders often transcode media on an as-needed basis since they lack the processing capability and/or volume of decodes to defray the cost of expensive encoding in advance. For example, user footage might be encoded at its highest quality for long term archival, and transcoded for consumption at individual devices according to their resolution (e.g., laptop, phone, television, etc.). Since action footage may be captured with wide-angle lenses, it is not uncommon for such footage to have a “transcoding cascade” before display (e.g., from archival wide-angle format (MP4), to a standard display resolution (MP4), to a streaming format (HLS), etc.).

As a practical matter, transcoding typically occurs downstream from the camera and may be performed by different devices, with different parameters, to suit a variety of different usages. This is particularly problematic in transcoding cascades, since the dynamic encoding configurations of previous transcoding stages may be inapplicable, or potentially even undesirable, in subsequent transcoding stages. Cascading lossy compression also slowly accumulates undesirable artifacts as more and more of the original data is lost. In other words, a transcoding of a previously lossily encoded media file suffers from both its original encoding losses as well as the subsequent encoding losses. This is exacerbated where the encoding stages do not share the same optimization strategies. For example, a constant quality (iso-quality) encoder is likely to have significant variance in bitrate based on image complexity—unfortunately, if it is naively paired with a constant bitrate (iso-bitrate) second encoding stage (e.g., trades-off quality for a constant bitrate), then the resulting bitstream is incorrectly optimized for both quality and bitrate.

Codec optimization strategy mismatches are likely to occur in consumer ecosystems that combine different devices with competing design criteria. To illustrate this point, most smart phones are assumed to be content consumers on QoS-based (quality of service) network bandwidth—thus, most smart phone codecs optimize for iso-bitrate delivery. In contrast, action cameras may capture footage that is intended for post-processing; thus, action camera codecs optimize for video quality (iso-quality).

New solutions for dynamic transcoding based on previous codec information are needed to improve the performance and/or capabilities of post-processing environments. Ideally, new solutions dynamically adapt transcoding parameters (e.g., target bitrate, etc.) by leveraging complexity analysis from previous stages (capture, encoding, transcoding, etc.). In other words, transcoding may leverage codec information from previous stages to avoid image analysis. As a related benefit, codec information may be lost in cascaded systems (e.g., due to lossy encoding, etc.)—codec information that is collected in earlier stages and preserved throughout the pipeline allows every stage to access minimally processed codec information.

As used herein, the term “pipeline” refers to a set of processing elements that process data in sequence, such that each processing element may also operate in parallel with the other processing elements. For example, a 3-stage pipeline may have first, second, and third processing elements that operate in parallel. During operation, the input of a second processing element includes at least the output of a first processing element, and the output of the second processing element is at least one input to a third processing element. While the following discussion is presented in the context of a pipeline with physical processing elements, artisans of ordinary skill in the related arts will readily appreciate that virtualized and/or software-based pipelines may be substituted with equal success.

The following discussion is presented in the context of content adaptive encoding metadata. More broadly, however, “codec information” refers to any parameters, metadata, and/or other data structure that constrains, is generated by, describes, or is derived from, the codec's processing of media content. While the following discussion is presented in the context of content adaptive encoding metadata, the concepts may be broadly extended to, and/or incorporate, content-based optimized and adaptive (COPA), content adaptive encoding (CAE), quality variable bitrate (QVBR), and/or any dynamic encoder metadata. Furthermore, the concepts described throughout may be leveraged by applications such as e.g., cloud playback, cloud storage, edit proxy generation, edit export generation, format adjustments (trimming, resolution, fps), encoding post-stabilization, etc. As but one such example, cloud-based real-time streaming playback implementations may leverage COPA metadata to minimize transcoding complexity; this may enable commodity codecs, real-time compute, and/or other aggressive compute constraints that are common in mobile ecosystems.

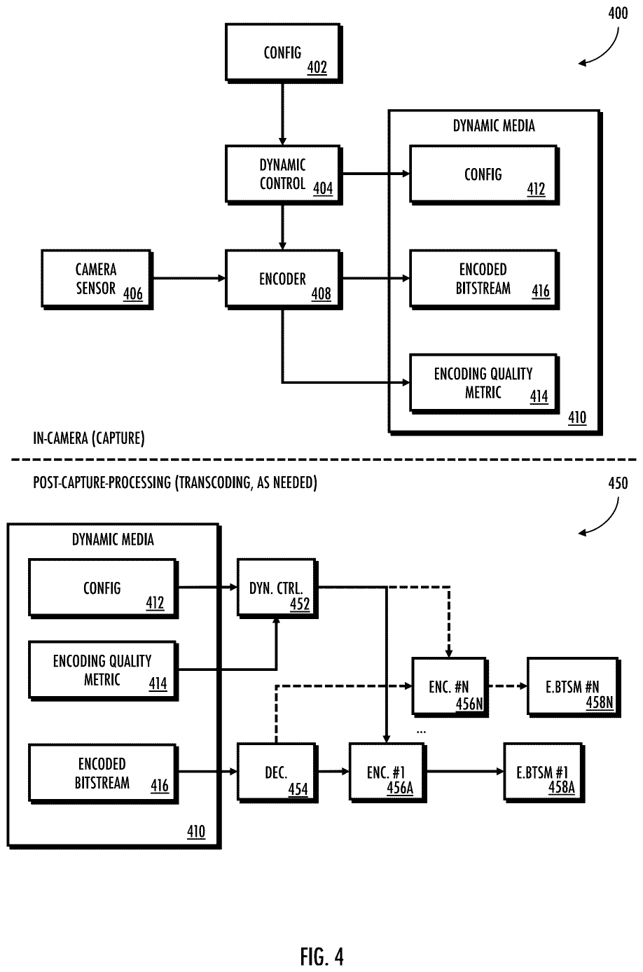

Referring now to FIG. 4, COPA metadata from dynamic encoding is leveraged for use within a mobile ecosystem. As shown in FIG. 4, a capture device 400 obtains a configuration file 402 for a dynamic encoder control 404. During video capture, the camera sensor 406 captures images, which are encoded to video by the in-camera encoder 408 based on encoder configurations generated by the dynamic encoder control 404.

In the illustrated example, the COPA metadata is based on pixel features from images that were used to dynamically select the bit rate, and encoder features from frames that were used to generate an encoding quality metric. The COPA metadata is stored within the dynamic media data structure 410 as a record of an updated configuration file 412 (which may also include bit rate selection), the encoding quality metric 414, and the encoded bitstream 416. Other implementations may use any variation of image features, encoder features, bit rate, quality metrics, frame rate, trimming, resolution information, and/or their derived metadata.

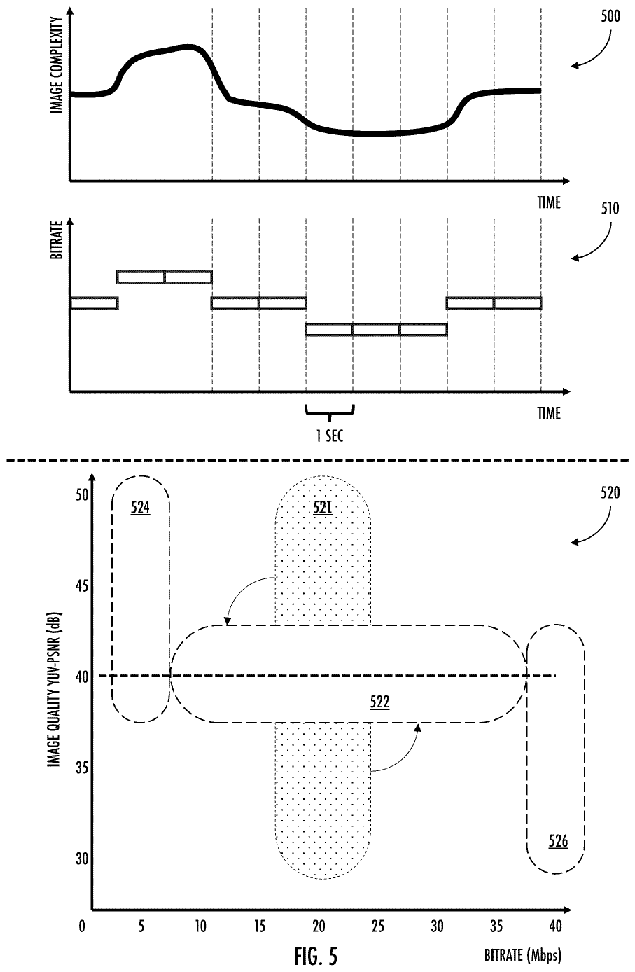

Consider a single-pass image quality-priority encoding (depicted in FIG. 5). Here, a video is divided into 1 second increments and encoded to generate an encoded video (e.g., 1080p resolution, 30 frames per second). Notably, the bitrate of the image quality-priority encoding of FIG. 5 is dynamically configured based on pixel features identified in previous stages and/or encoding features identified in previous encoded frames. Pixel features and encoding features are used as proxies to predict image complexity, since image complexity may not be directly measurable.

As shown in a first plot 500, the image complexity varies over time. Changes in complexity are forecasted by pixel features and/or encoding features, which are then used to dynamically configure the bitrate of the encoder (seen in second plot 510).

The third plot 520 of FIG. 5 plots the image quality of each 1 second segment of video as a function of bitrate. Here, the image quality is compared by measuring the differences between the reference video and its counterpart encoded video. Importantly, the iso-quality distribution 522 provides relatively consistent image quality across a wide range of bitrates (a constant bit rate distribution 521 is shown for comparison). Notably, the range of adjustment is limited, thus certain configurations may result in outlying behavior. For example, image quality may increase when the bitrate drops to a “floor” bitrate (as represented by floor region 524), and decrease when the bitrate rises to a “ceiling” (as represented by ceiling region 526).

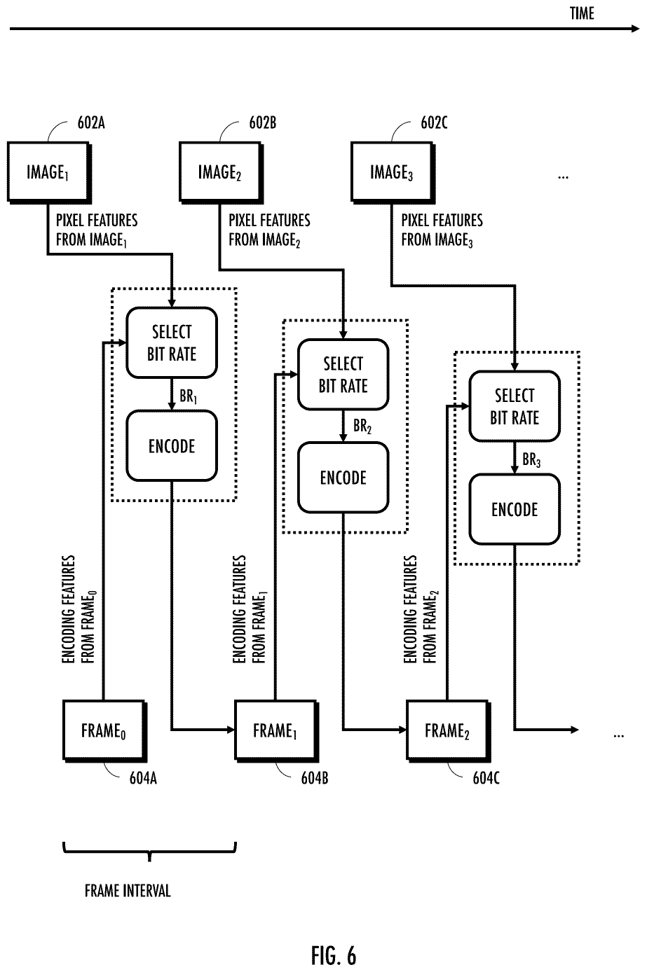

FIG. 6 is a graphical representation of a single-pass iso-quality encoding process. As shown, a sequence of images (image₁ 602A, image₂ 602B, image₃ 602C) is encoded into a sequence of frames (frame₀ 604A, frame₁ 604B, frame₂ 604C) in a single-pass. For example, the pixel features from image₁ 602A and the encoding features from frame₀ 604A are used to select a first bitrate₁ (BR₁), the encoder is configured according to the first bitrate₁ to generate frame₁ 604B. Similarly, the pixel features from image₂ 602B and the encoding features from frame₁ 604B are used to select a second bitrate₂ (BR₂), the encoder is configured according to the second bitrate₂ to generate frame₂ 604C, etc.

Here, “pixel features” refer to metadata extracted from the raw pixel values and/or image processing (e.g., during the first stage 102 of FIG. 1). Examples of pixel features may include, without limitation, the average, standard deviation, skewness, kurtosis, etc. of pixel values. Pixel features may additionally be subdivided into spatial features and temporal features. Examples of spatial pixel features include Gray-Level Co-Occurrence Matrix (GLCM), colorfulness measures, noise measures, and/or spatial information (as defined under ITU-T P.910, Subjective Video Quality Assessment Methods for Multimedia Applications, Recommendation, International Telecommunication Union, 2022, incorporated herein by reference in its entirety). Temporal features may be computed for each pair of temporally adjacent images; temporal features may include normalized cross-correlation, average of temporal coherence, standard deviation of temporal coherence, and/or temporal information (as defined under ITU-T P.910, referred to above). More broadly, any metadata that is derived, identified, or generated from the image signal processing of sensed light information into pixel data may be substituted with equal success by artisans of ordinary skill in the related arts, given the contents of the present disclosure.

Here, “encoding features” refer to metadata extracted from a previously encoded frame of video (e.g., during the third stage 106 of FIG. 1). Examples of encoding features may include, without limitation, the quantization parameters (QP) of the encoded frame (aggregated by median, minimum, maximum, amplitude between maximum and minimum, etc.), the number of bits of the encoded frame (aggregated by average, minimum, maximum, P-frame maximum, P-frame amplitude, etc.), YUV-PSNR between the encoded frame and the reference frame (aggregated by average, standard deviation, minimum, maximum, P-frame maximum, P-frame amplitude, etc.), percentage of intra blocks in the encoded frame (aggregated by median, minimum, P-frame maximum, P-frame amplitude, etc.), percentage of skip blocks in the encoded frame (aggregated by median, P-frame minimum, maximum, P-frame amplitude, etc.), and/or percentage of merge blocks in the encoded frame (aggregated by median, minimum, maximum, P-frame minimum, P-frame amplitude, etc.). More broadly, any metadata that is derived, identified, or generated from the encoding of previous frames may be substituted with equal success by artisans of ordinary skill in the related arts, given the contents of the present disclosure.

Dynamic codec operation is also described in greater detail within U.S. application Ser. No. 18/423,533, filed Jan. 26, 2024, and entitled “METHODS AND APPARATUS FOR DYNAMIC CODEC CONFIGURATION”, the foregoing previously incorporated by reference in its entirety.

Referring back to FIG. 4, the dynamic media data structure 410 is provided to a downstream transcoding device 450. For example, an action camera may transmit the dynamic media data structure 410 to a nearby smart phone for real-time viewing/editing. The downstream transcoding device 450 extracts the COPA metadata comprising the updated configuration file 412, the encoding quality metric 414, and the encoded bitstream 416.

In this example, the downstream transcoding device 450 transcodes the previously encoded media into other formats as-needed. As one such example, a user wants to view their captured video on their smart phone to ensure they “got the shot”; the smart phone may need to transcode the live streaming feed from the action camera to the smart phone's display format (e.g., frame rate, resolution, etc.) in real-time. If the user also wants to post a quick edit online, they may need to transcode yet again into another output video with different encoding parameters (e.g., bitrate, network bandwidth, etc.). Encoding parameters affect video quality in different ways; e.g., motion is strongly affected by frame rate, image details are affected by resolution, etc. Thus, each of these different transcodes needs to consider image complexity and adjust its encoder behavior accordingly.

Logically, transcoding may be split into two or more steps: an initial decode and one or more encodes. The decoder 454 decodes the encoded bitstream 416 into a first set of video frames characterized by a first bit rate. The first set of video frames are provided to one or more encoders (e.g., first encoder 456A . . . second encoder 456N, etc.) for encoding based on encoder configurations generated by the dynamic encoder control 452. The dynamic encoder control 452 obtains COPA metadata which includes both the updated configuration file 412 and the encoding quality metric 414.

The encoder configurations from the dynamic encoder control 452 are used to configure one or more encoders (e.g., first encoder 456A . . . second encoder 456N, etc.) on a frame-by-frame basis, by group of pictures (GOP), or according to other spatial-temporal organization. In other words, the dynamic encoder control 452 may adjust the encoder optimization strategies mid-encode. Each encoder generates a corresponding encoded bitstream (e.g., first encoded bitstream 458A . . . second encoded bitstream 458N, etc.).

Depending on application, the encoded bitstreams may be generated in parallel and/or sequentially. For example, a first encoded bitstream 458A may be played in real-time for the user to view their captured video on their smart phone; the second encoded bitstream 458N may be generated concurrently (in real-time) or later (at best-effort) for transmission to the cloud, writing to archival memory, etc. Various other applications may be substituted with equal success, given the contents of the present disclosure.

Propagating COPA metadata between transcoding stages allows the downstream codecs to adjust their encoding strategy (iso-quality, iso-bitrate, etc.) to match, augment, and/or compensate—for the previous stages' encoding strategy. For example, the second stage of encoders can match its encoding strategy to the previous stage such that optimizations are the same (or similar) and much of the previous image analysis can be re-used. In other otherwords, the second stage of encoders can reuse the image analysis from the first stage of encoding, to minimally process features that were previously identified.

Furthermore, when the encoding strategy is changed between the first stage and the second stage, the dynamic encoder control may be able to re-map/translate between encoder configurations to preserve quality and/or improve performance. For example, an iso-quality encoder that receives an iso-bitrate encoded bitstream may switch between different bitrate-quality heuristics, so as to maximize the image quality that is preserved. Re-mapping based on information from previous stages is more likely to preserve data fidelity, when compared to “blind” encodings that are based on assumptions.

### Dynamic Encoder Control

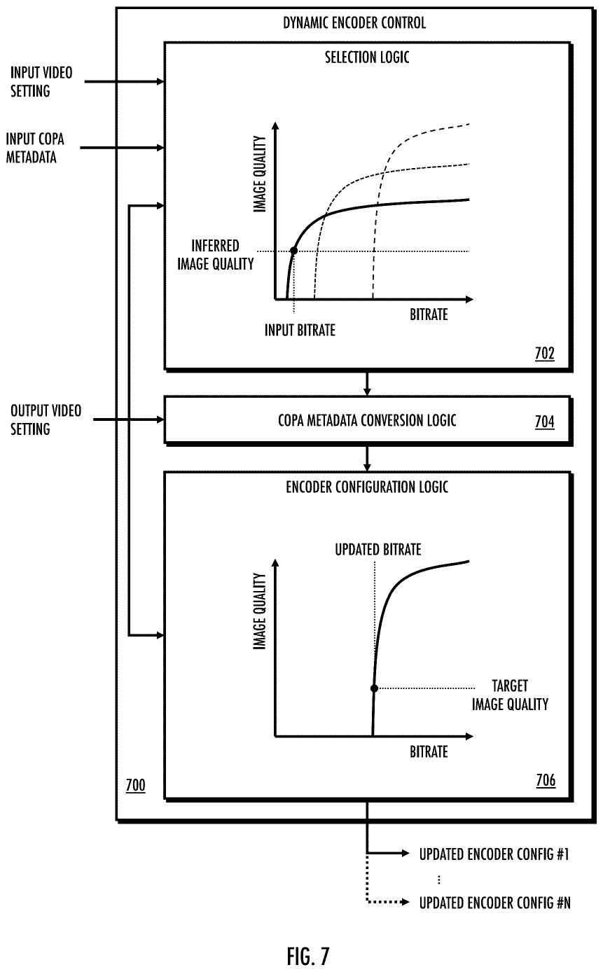

Various aspects of of the present disclosure are directed to dynamic encoder control based on COPA metadata. FIG. 7 is a logical block diagram of dynamic encoder control logic 700 which dynamically generates encoder configurations to re-map/translate between encoder configurations. In one specific implementation, the dynamic encoder control logic 700 includes a selection logic 702, metadata conversion look-up logic 704, and an encoder configuration logic 706.

While the following discussion is presented in the context of COPA metadata, any “dynamic” codec information may be substituted with equal success. Codec information is “dynamic” when it constrains, is generated by, describes, or is derived from, changes in features of the encoded media. In one illustrative embodiment, COPA metadata describes the codec parameters that corresponds to individual frames or groups of frames of the video-COPA metadata may include image features and/or encoding features for each frame or group-of-pictures (GOP). COPA metadata may be aligned on a frame-by-frame basis, a group-of-pictures (GOP), and/or any other organization of video frames. Other variants may use time stamps and/or alignment timing between tracks of a data structure.

A variety of different types and/or modalities of dynamic metadata may be substituted and/or used in conjunction with the COPA metadata described throughout. For example, dynamic metadata may be condensed (summarized) into as little as a single value or enumeration that represents compressability, complexity, etc. Dynamic metadata may also be fitted or modeled as an arithmetic/logical relationship or expression (e.g., a rate distortion (RD) curve may be modeled using polynomial, logarithmic, and/or linear coefficients). Still other types of dynamic metadata may provide measured, captured, or otherwise sensed metadata that may be processed as needed (e.g., temporal and/or spatial pixel-based features, etc.). Artisans of ordinary skill in the related arts, given the contents of the present disclosure will readily appreciate that a variety of other forms of dynamic metadata may be substituted with equal success.

In FIG. 7, the selection logic 702 selects an encoder optimization strategy for the current frame(s), group of pictures (GOP), etc. Here, the selection logic infers an image quality of the frame(s) or GOP, and identifies other bitrates that would achieve substantially similar image quality. Notably, many different bitrate-quality curves can be used to achieve the same image quality, however, their kinking behavior reflects their specific trade-offs of robustness and performance (discussed elsewhere). In other words, different encoder optimization strategies may be selected for different behaviors. In this case, the selection logic selects an encoder optimization strategy with a bitrate-quality curve that allows for higher image quality, with less robustness under lower bitrates (e.g., bitrate may be traded for more image quality).

More generally, bitrate transcodes may be used to adapt bitrates to e.g., optimize streaming quality, reduce file size, and/or accommodate device considerations and/or network conditions. Variable bitrate encoding (VBR) adjusts bitrate dynamically based on content complexity, whereas constant bitrate encoding (CBR) attempts to keep a consistent bitrate (even at reduced coding efficiencies). For relative comparison, 10-20 Mbps is commonly used to stream 4K video with an original bitrate of 50 Mbps; the compression trades lower image quality for robustness (important for network variance).

Here, the selection logic 702 obtains an input video setting and input COPA metadata for the frame(s) or group of pictures (GOP). In the illustrated example, the input video setting may be bitrate and the input COPA metadata may include the pixel features and the encoding features of the frame(s) or GOP. The selection logic 702 may be implemented as a look-up table that stores output values based on input values. Look-up tables are useful for data that has pre-defined relationships. For example, previous analysis of image content libraries may be used to associate bitrate, pixel features, encoding features, etc. with image quality (based on bitrate-quality curves described in FIGS. 2 and 3 above, etc.); these associations may be used to infer an image quality of the input video based on the inputs.

Artisans of ordinary skill in the related arts, given the contents of the present disclosure, will readily appreciate that look-up tables are merely illustrative and any mapping logic may be substituted with equal success. For instance, computer vision and/or conventional image analysis may be used to explicitly map image quality to bitrate, etc.

As a brief aside, different transcoding operations may consider the COPA metadata for the frame or GOP, the user's desired transcode, and/or device considerations (e.g., network connectivity, etc.). Different transcode operations may be affected in different ways—for example, frame rate transcodes may be more sensitive to motion content, resolution transcodes may be more sensitive to high detail content, etc. The following discussions explore other transcoding considerations.

A frame rate transcode (also referred to as “trimming”) changes the frame rate. Since the illusion of motion is achieved through changes between frames, a transcoding to different frame rates may affect the perceived image quality. For example, an input video of 60 frames per second (fps) may be trimmed down to 30 fps (a ratio of 2:1) by removing every other frame, or trimmed up to 120 fps (1:2) by duplicating and/or interpolating frames, etc. Other ratios may require frame interpolation to create intermediary frames to maintain fluid motion. Frame rate transcodes are often used to address codec compatibility, playback smoothness, broadcast standards, etc. Examples may include e.g., NTSC transcode (24 fps to/from 30 fps), PAL transcode (24 fps to/from 25 fps), etc. Certain types of post-processing may also incorporate frame rate adjustments (e.g., speed-up, slow motion, etc.).

A resolution transcode (also referred to as “scaling”) changes the frame resolution. For example, an input video of 4K resolution (3840×2160) may be downscaled to 1080p/1080i (1920×1080), or upscaled to 8K (7680×4320), etc. Scaling transcodes are commonly used to address differences in display sizes, aspect ratios, etc. In fact, different aspect ratios may use the same naming convention; e.g., 4K may refer to 16:9 (3840×2160) or 17:9 (4096×2160), etc. In some cases, scaling may require clipping and/or padding to adjust for differences in aspect ratio.

As shown in FIG. 7, the metadata conversion look-up logic 704 converts COPA metadata from a previous transcode into COPA metadata for the current transcode. In other words, since COPA metadata is associated with specific frames (frame-by-frame) or GOPs, the COPA metadata may need to be modified to cause, enable, or otherwise describe the transcoding operations of the current stage. In some implementations, the previous COPA metadata track is overwritten with the current metadata, in other implementations the previous COPA metadata track is updated with the current metadata. Updates may be chronological (e.g., appended to the previous record, etc.) or structural (e.g., written in specific locations of the data structure).

In the illustrated embodiment, the COPA metadata may describe encoder behaviors (and differences) between the first bitrate-quality heuristic and the second bitrate-quality heuristic. More directly, an encoder optimization strategy with the first bitrate-quality optimization strategy may infer a first image quality from COPA metadata (pixel features and/or encoding features) that maps to a first bitrate, whereas a second bitrate-quality optimization strategy may infer a second image quality and map the same COPA metadata to a second bitrate. By re-using the COPA metadata that is associated frame-by-frame (or to groups of frames) from a previous encoder, each encoder can use its own optimization strategy without re-deriving COPA metadata. Re-using COPA metadata avoids duplicative processing and preserves metadata from earlier stages in processing (this prevents the cumulative effects of irrelevant and/or erroneous metadata).

In some variants, the conversions may be defined ahead of time and stored within a mapping data structure. For example, a conversion between two different bitrate-quality heuristics may be captured within a look-up table or similar mapping logic. In other variants, the conversion may be based on the underlying transcoding relationships; e.g., a trimming transcode (doubling or halving frame rate) may be implemented by duplicating or puncturing the corresponding COPA metadata for each frame that is duplicated or punctured. Similarly, a resolution transcode might divide image features and/or encoding features by the resolution change (e.g., 4K to 1080p transcode would divide by 4, etc.). In other words, a resolution-based transcode may e.g., scale, warp, crop, or otherwise modify COPA metadata in accordance with the resolution changes.

More generally, any operational, spatial, and/or temporal modifications may be reflected within the updated COPA metadata. A record of the transcoding history for a media file may be useful to analyze, ignore, amplify, attenuate, and/or synthesize COPA metadata in other post-processing applications.

Referring back to FIG. 7, the encoder configuration logic 706 generates the encoder configuration based on the selected encoder optimization strategy and the updated COPA metadata. In one embodiment, the encoder configuration is provided to a codec via an API call (described elsewhere). Encoder configurations are described in greater detail within U.S. application Ser. No. 18/423,533, filed Jan. 26, 2024, and entitled “METHODS AND APPARATUS FOR DYNAMIC CODEC CONFIGURATION”, the foregoing previously incorporated by reference in its entirety.

Here, the updated COPA metadata is provided with the stage's desired output video settings to an encoder configuration logic 706 to determine the video settings for the current encoding stage. In one implementation, the encoder configuration logic 706 may include a look-up table that maps output video settings to the encoder parameters. Other variants may determine encoder parameters using e.g., defined relationships, heuristics, or other schemes. As shown, multiple encoding configurations may be generated in parallel and/or sequentially.

While the foregoing discussion is presented in terms of playback considerations (e.g., trimming, resolution, bitrate, etc.), the concepts may be broadly applied to other media applications including e.g., live streaming, archival, post-processing, etc. More directly, an encoder configuration may configure the codec (or encoder) to encode to a specific frame rate, resolution, protocol, and/or any other format/data structure.

### Cumulative Metadata

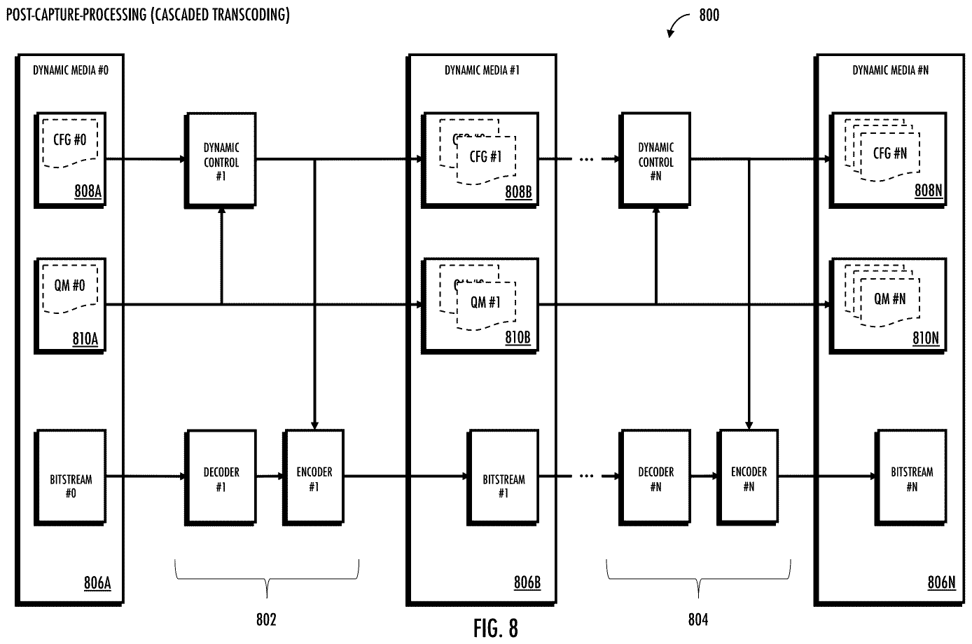

Various aspects of of the present disclosure are directed to cumulative metadata structures. FIG. 8 is a logical block diagram of a transcoding cascade 800 which cumulatively updates dynamic media data structures that correspond to transcoded bitstream outputs. As shown, a first transcoding stage 802 and a second transcoding stage 804 each comprise a decoder, encoder, and dynamic encoder control logic (discussed elsewhere). In the illustrated embodiment, cumulative COPA metadata is stored within data structures (first dynamic media 806A, second dynamic media 806B, . . . third dynamic media 806N, etc.) that are updated and/or preserved end-to-end within a closed ecosystem (capture, intermediate transcoding (if any), and post-processing).

In the illustrated example, COPA metadata is stored within the dynamic media data structures as encoder configurations (first configuration 808A, second configuration 808B, . . . third configuration 808N, etc.) and encoding quality metrics (first metric 810A, second metric 810B, . . . third metric 810N, etc.). The dynamic media may also include the encoded bitstream as another media track (a “sidecar” configuration, e.g., as used by general purpose metadata format (GPMF) tracks) or may be wholly separate from the media track (not shown). The dynamic media data structures may additionally include referential information to identify correspondence between the COPA metadata and their media tracks (e.g., frame-by-frame basis, GOP basis, and/or according to any other spatial-temporal correspondence). More generally, any variation of image features, encoder features, bit rate, quality metrics, frame rate, trimming, resolution information, and/or their derived metadata may be substituted with equal success.

In some cases, the accumulated COPA metadata may be standardized for use within an open ecosystem. Here, an “ecosystem” refers to a collection of hardware, software, and/or logic devices that interoperate with one another. A “closed ecosystem” refers to an ecosystem that is directly or indirectly controlled by an authority entity (e.g., a manufacturer that promulgates a proprietary communication protocol between its devices, etc.); an “open ecosystem” refers to an ecosystem that is uncontrolled or that distributes control among its members. Purely closed and open ecosystems are rare-most ecosystems combine and/or hybridize aspects of control. For example, a standardization body may promulgate a standard that device manufacturers may comply with in part, or whole, etc. One such example of a standardization body is the MPEG (Moving Picture Experts Group) standard that is promulgated by the International Organization for Standardization (ISO) and the International Electrotechnical Commission (IEC) through their Joint Technical Committee 1 (JTC 1) on Information Technology.

During operation, the first transcoding stage 802 obtains the first dynamic media 806A, and first configuration 808A and first metric 810A. First, the first dynamic media 806A is decoded; then, the first configuration 808A and first metric 810A are used to select a new encoding configuration. The new encoding configuration is used to transcode the media to a new dynamic media; which has a new quality. The first dynamic media 806A is then updated to second dynamic media 806B e.g., the first configuration 808A is updated to the second configuration 808B, the first metric 810A is updated to the second metric 810B. Updates may add, delete, replace, augment, and/or ignore, the previously stored COPA metadata and/or bitstream. The process may be repeated for each subsequent cascade of the transcode (e.g., the second dynamic media 806B is updated to third dynamic media 806N, the second configuration 808B is updated to the third configuration 808N, the second metric 810B is updated to the third metric 810N, etc.).

In slightly more detail, the encoder obtains the decoded image from the decoder. Based on the previous encoder configuration and the retrieved characteristics of the decoded image the encoder can assess an image complexity. Notably, the encoder can re-use previously identified information (e.g., bitrate, image features, encoder features, etc.) to assess image complexity.

As but one such example, image complexity may be inferred from the previous encoder configuration. For example, a point on a previous bitrate-curve that is below the kink suggests that the current bitrate-curve should emphasize robustness (lowering the plateau to provide commensurate quality to that bitrate). In contrast, a point on the previous bitrate-curve that is above the kink suggests that the current bitrate-curve can improve performance (e.g., the plateau may be raised). Here, encoder configuration based heuristics are much more efficient than trying to identify image quality “from scratch”, based on image analysis.

As another such example, image complexity analysis may also re-use features from previous assessments. This enables image analysis to be performed with a fewer number of steps. Notably, while the codec can perform its analysis independent of earlier stages, the underlying content (and its derivatives and analytes) are the same. Thus, image features may be retrieved from memory instead of calculated from image data. Similarly, encoder features may be retrieved from memory, instead of windowed searching during encoding.

Importantly, however, different encoder strategies make decisions that differ between stages. Some changes are lossless and may be reversed in downstream processing (if known), other changes are lossy and cannot be reversed. For example, frame duplication for a trimming transcode can be easily undone if the duplicated frames are identified. Similarly, certain types of interpolation, warping, duplication, etc. for resolution changes may be reverted if the downstream codec is aware of their insertion.

Furthermore, informed reversal of lossy changes is preferred over blind reversion. As previously noted, transcoding may change between different bitrate-quality curves with substantially equivalent image quality—however, some amount of information may be lost. Consider, for example, a cascading transcode that reduces both bitrate and quality—the order of transcoding operation affects the resulting bitstream. Reducing bitrate first may aggressively affect quality, which cannot be recovered later. Thus, reducing quality in the first stage will conserve as much information as possible, before the bitrate reduction stage. As another such example, a cascading transcode that increases resolution and frame rate may achieve subjectively better results when increasing resolution first and then increasing frame rate (as opposed to increasing frame rate and then resolution). In otherwords, information from previous stages may be useful to improve downstream results.

### System Architecture

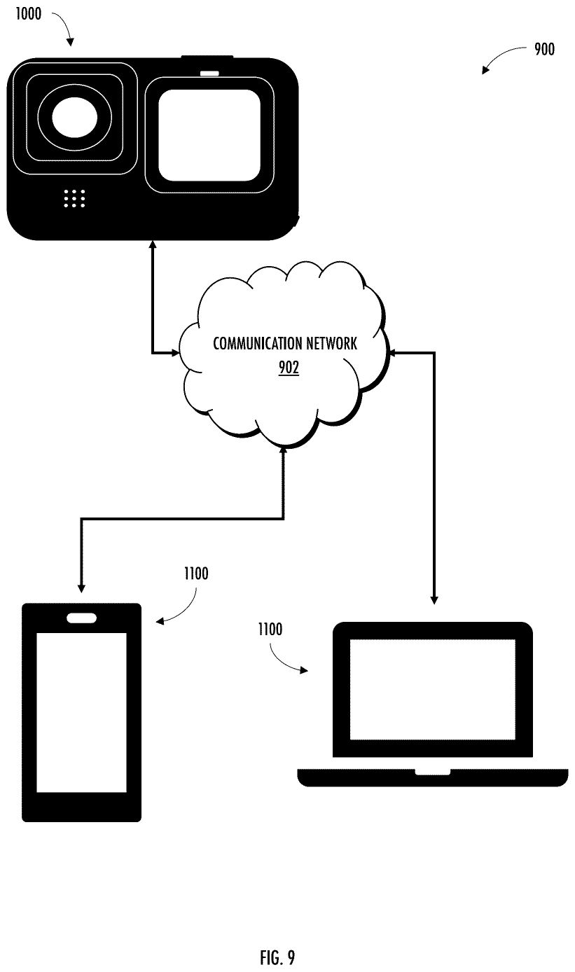

FIG. 9 is a logical block diagram of the system 900 that includes: a capture device 1000, one or more transcoding devices 1100, and a communication network 902. The capture device 1000 may capture data and encode the captured data in real-time (or near real-time). The captured data may be transferred to the transcoding devices 1100 directly or via communication network 902. In some cases, the captured media may be live streamed (e.g., subject to real-time or near real-time scheduling requirements, etc.).

As used herein, the term “real-time” refers to tasks that must be performed within definitive constraints; for example, a video camera must capture each frame of video at a specific rate of capture (e.g., 30 frames per second (fps)). As used herein, the term “near real-time” refers to tasks that must be performed within definitive time constraints once started; for example, a smart phone may use near real-time rendering for each frame of video at its specific rate of display, however some queueing time may be allotted prior to display.

Unlike real-time tasks, so-called “best-effort” refers to tasks that can be handled with variable bit rates and/or latency. Best-effort tasks are generally not time sensitive and can be run as low-priority background tasks (for even very high complexity tasks), or queued for cloud-based processing, etc.

While the following discussion is presented in the context of a capture device 1000 and transcoding devices 1100, artisans of ordinary skill in the related arts will readily appreciate that the techniques may be broadly extended to other topologies and/or systems. For example, the capture device 1000 may transfer an iso-quality encoded video to a streaming server for live streaming (e.g., which may require re-encoding to iso-bitrate formats) to a streaming client. As another example, a capture device may capture media at constant bit rate (possibly with metadata) which is provided to an encoding device for iso-quality encoding.

The following discussion provides functional descriptions for various logical entities of the system 900. Artisans of ordinary skill in the related art will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the system 900 is separately provided below.

The techniques described throughout may be broadly applicable to consumer electronics devices such as cameras including action cameras, digital cameras, digital video cameras; cellular phones; laptops; smart watches; and/or IoT devices. For example, a smart phone or laptop may be able to capture and process video. Various other applications may be substitute with equal success by artisans of ordinary skill, given the contents of the present disclosure.

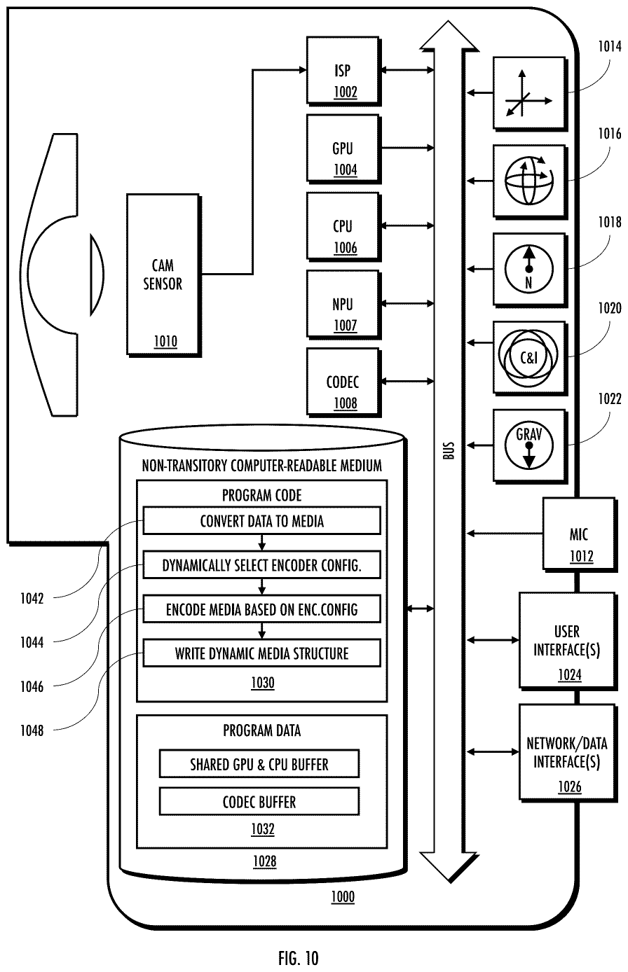

FIG. 10 is a logical block diagram of a capture device 1000. The capture device 1000 includes: a sensor subsystem, a user interface subsystem, a communication subsystem, a control and data subsystem, and a bus to enable data transfer. The following discussion provides a specific discussion of the internal operations, design considerations, and/or alternatives, for each subsystem of the capture device 1000.

Functionally, the sensor subsystem senses the physical environment and captures and/or records the sensed environment as data. In some embodiments, the sensor data may be stored as a function of capture time (so-called “tracks”). Tracks may be synchronous (aligned) or asynchronous (non-aligned) to one another. In some embodiments, the sensor data may be compressed, encoded, and/or encrypted as a data structure (e.g., MPEG, WAV, etc.)

The illustrated sensor subsystem includes: a camera sensor 1010, a microphone 1012, an accelerometer (ACCL 1014), a gyroscope (GYRO 1016), and a magnetometer (MAGN 1018).

Other sensor subsystem implementations may multiply, combine, further sub-divide, augment, and/or subsume the foregoing functionalities within these or other subsystems. For example, two or more cameras may be used to capture panoramic (e.g., wide or 360°) or stereoscopic content. Similarly, two or more microphones may be used to record stereo sound.

In some embodiments, the sensor subsystem is an integral part of the capture device 1000. In other embodiments, the sensor subsystem may be augmented by external devices and/or removably attached components (e.g., hot-shoe/cold-shoe attachments, etc.) The following sections provide detailed descriptions of the individual components of the sensor subsystem.

A camera lens bends (distorts) light to focus on the camera sensor 1010. In one specific implementation, the optical nature of the camera lens is mathematically described with a lens polynomial. More generally however, any characterization of the camera lens' optical properties may be substituted with equal success; such characterizations may include without limitation: polynomial, trigonometric, logarithmic, look-up-table, and/or piecewise or hybridized functions thereof. In one variant, the camera lens provides a wide field-of-view greater than 90°; examples of such lenses may include e.g., panoramic lenses 120° and/or hyper-hemispherical lenses 180°.

The camera sensor 1010 senses light (luminance) via photoelectric sensors (e.g., CMOS sensors). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

More generally however, the various techniques described herein may be broadly applied to any camera assembly; including e.g., narrow field-of-view (30° to) 90° and/or stitched variants (e.g., 360° panoramas). While the foregoing techniques are described in the context of perceptible light, the techniques may be applied to other EM radiation capture and focus apparatus including without limitation: infrared, ultraviolet, and/or X-ray, etc.

As a brief aside, “exposure” is based on three parameters: aperture, ISO (sensor gain) and shutter speed (exposure time). Exposure determines how light or dark an image will appear when it's been captured by the camera(s). During normal operation, a digital camera may automatically adjust one or more settings including aperture, ISO, and shutter speed to control the amount of light that is received. Most action cameras are fixed aperture cameras due to form factor limitations and their most common use cases (varied lighting conditions)—fixed aperture cameras only adjust ISO and shutter speed. Traditional digital photography allows a user to set fixed values and/or ranges to achieve desirable aesthetic effects (e.g., shot placement, blur, depth of field, noise, etc.).

The term “shutter speed” refers to the amount of time that light is captured. Historically, a mechanical “shutter” was used to expose film to light; the term shutter is still used, even in digital cameras that lack of such mechanisms. For example, some digital cameras use an electronic rolling shutter (ERS) that exposes rows of pixels to light at slightly different times during the image capture. Specifically, CMOS image sensors use two pointers to clear and write to each pixel value. An erase pointer discharges the photosensitive cell (or rows/columns/arrays of cells) of the sensor to erase it; a readout pointer then follows the erase pointer to read the contents of the photosensitive cell/pixel. The capture time is the time delay in between the erase and readout pointers. Each photosensitive cell/pixel accumulates the light for the same exposure time, but they are not erased/read at the same time since the pointers scan through the rows. A faster shutter speed has a shorter capture time, a slower shutter speed has a longer capture time.

A related term, “shutter angle” describes the shutter speed relative to the frame rate of a video. A shutter angle of 360° means all the motion from one video frame to the next is captured, e.g., video with 24 frames per second (FPS) using a 360° shutter angle will expose the photosensitive sensor for 1/24^{th} of a second. Similarly, 120 FPS using a 360° shutter angle exposes the photosensitive sensor 1/120th of a second. In low light, the camera will typically expose longer, increasing the shutter angle, resulting in more motion blur. Larger shutter angles result in softer and more fluid motion, since the end of blur in one frame extends closer to the start of blur in the next frame. Smaller shutter angles appear stuttered and disjointed since the blur gap increases between the discrete frames of the video. In some cases, smaller shutter angles may be desirable for capturing crisp details in each frame. For example, the most common setting for cinema has been a shutter angle near 180°, which equates to a shutter speed near 1/48^{th} of a second at 24 FPS. Some users may use other shutter angles that mimic old 1950's newsreels (shorter than 180°).

The camera resolution directly corresponds to light information. In other words, the Bayer sensor may match one pixel to a color and light intensity (each pixel corresponds to a photosite). However, the camera resolution does not directly correspond to light information. Some high-resolution cameras use an N-Bayer sensor that groups four, or even nine, pixels per photosite. During image signal processing, color information is re-distributed across the pixels with a technique called “pixel binning”. Pixel-binning provides better results and versatility than just interpolation/upscaling. For example, a camera can capture high resolution images (e.g., 108 MPixels) in full-light; but in low-light conditions, the camera can emulate a much larger photosite with the same sensor (e.g., grouping pixels in sets of 9 to get a 12 MPixel “nona-binned” resolution). Unfortunately, cramming photosites together can result in “leaks” of light between adjacent pixels (i.e., sensor noise). In other words, smaller sensors and small photosites increase noise and decrease dynamic range.

The microphone 1012 senses acoustic vibrations and converts the vibrations to an electrical signal (via a transducer, condenser, etc.) The electrical signal may be further transformed to frequency domain information. The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.)

More generally however, the various techniques described herein may be broadly applied to any integrated or handheld microphone or set of microphones including, e.g., boom and/or shotgun-style microphones. Multiple microphones may be used to collect stereo sound and/or enable audio processing. For example, any number of individual microphones can be used to constructively and/or destructively combine acoustic waves (also referred to as beamforming).

The inertial measurement unit (IMU) includes one or more accelerometers, gyroscopes, and/or magnetometers. The accelerometer (ACCL 1014) measures acceleration and gyroscope (GYRO 1016) measure rotation in one or more dimensions. These measurements may be mathematically converted into a four-dimensional (4D) quaternion to describe the device motion, and electronic image stabilization (EIS) may be used to offset image orientation to counteract device motion (e.g., CORI/IORI 1020). The magnetometer (MAGN 1018) may provide a magnetic north vector (which may be used to “north lock” video and/or augment location services such as GPS), similarly the accelerometer (ACCL 1014) may also be used to calculate a gravity vector (GRAV 1022).

Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

More generally, however, any scheme for detecting device velocity (direction and speed) may be substituted with equal success for any of the foregoing tasks. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Functionally, the user interface subsystem 1024 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

The user interface subsystem 1024 may include: a touchscreen, physical buttons, and a microphone. Input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

Other user interface subsystems may multiply, combine, further sub-divide, augment, and/or subsume the foregoing functionalities within these or other subsystems. For example, the audio input may incorporate elements of the microphone (discussed above with respect to the sensor subsystem). Similarly, IMU based input may incorporate the aforementioned IMU to measure “shakes”, “bumps” and other gestures.

The user interface subsystem 1024 is incorporated within the capture device 1000. In other embodiments, the user interface subsystem may be augmented by external devices (such as the transcoding devices 1100, discussed below) and/or removably attached components (e.g., hot-shoe/cold-shoe attachments, etc.) The following sections provide detailed descriptions of the individual components of the sensor subsystem.

The user interface subsystem 1024 may include a touchscreen panel. A touchscreen is an assembly of a touch-sensitive panel that has been overlaid on a visual display. Typical displays are liquid crystal displays (LCD), organic light emitting diodes (OLED), and/or active-matrix OLED (AMOLED). Touchscreens are commonly used to enable a user to interact with a dynamic display, this provides both flexibility and intuitive user interfaces. Within the context of action cameras, touchscreen displays are especially useful because they can be sealed (waterproof, dust-proof, shock-proof, etc.)

Most commodity touchscreen displays are either resistive or capacitive. Generally, these systems use changes in resistance and/or capacitance to sense the location of human finger(s) or other touch input. Other touchscreen technologies may include, e.g., surface acoustic wave, surface capacitance, projected capacitance, mutual capacitance, and/or self-capacitance. Yet other analogous technologies may include, e.g., projected screens with optical imaging and/or computer-vision.

The user interface subsystem 1024 may also include mechanical buttons, keyboards, switches, scroll wheels and/or other mechanical input devices. Mechanical user interfaces are usually used to open or close a mechanical switch, resulting in a differentiable electrical signal. While physical buttons may be more difficult to seal against the elements, they are nonetheless useful in low-power applications since they do not require an active electrical current draw. For example, many BLE applications may be triggered by a physical button press to further reduce GUI power requirements.

More generally, however, any scheme for detecting user input may be substituted with equal success for any of the foregoing tasks. While the foregoing techniques are described in the context of a touchscreen and physical buttons that enable user data entry, artisans of ordinary skill in the related arts will readily appreciate that any of their derivatives may be substituted with equal success.

Audio input may incorporate a microphone and codec (discussed above) with a speaker. As previously noted, the microphone can capture and convert audio for voice commands. For audible feedback, the audio codec may obtain audio data and decode the data into an electrical signal. The electrical signal can be amplified and used to drive the speaker to generate acoustic waves.

As previously noted, the microphone and speaker may have any number of microphones and/or speakers for beamforming. For example, two speakers may be used to provide stereo sound. Multiple microphones may be used to collect both the user's vocal instructions as well as the environmental sounds.

Functionally, the communication subsystem may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) The data interfaces are configured to read/write data to a removeable non-transitory computer-readable medium (e.g., flash drive or similar memory media).

The illustrated network/data interface 1026 may include network interfaces including, but not limited to: Wi-Fi, Bluetooth, Global Positioning System (GPS), USB, and/or Ethernet network interfaces. Additionally, the network/data interface 1026 may include data interfaces such as: SD cards (and their derivatives) and/or any other optical/electrical/magnetic media (e.g., MMC cards, CDs, DVDs, tape, etc.)

The communication subsystem including the network/data interface 1026 of the capture device 1000 may include one or more radios and/or modems. As used herein, the term “modem” refers to a modulator-demodulator for converting computer data (digital) into a waveform (baseband analog). The term “radio” refers to the front-end portion of the modem that upconverts and/or downconverts the baseband analog waveform to/from the RF carrier frequency.

As previously noted, communication subsystem with network/data interface 1126 may include wireless subsystems (e.g., 5th/6th Generation (5G/6G) cellular networks, Wi-Fi, Bluetooth (including, Bluetooth Low Energy (BLE) communication networks), etc.) Furthermore, the techniques described throughout may be applied with equal success to wired networking devices. Examples of wired communications include without limitation Ethernet, USB, PCI-e. Additionally, some applications may operate within mixed environments and/or tasks. In such situations, the multiple different connections may be provided via multiple different communication protocols. Still other network connectivity solutions may be substituted with equal success.

More generally, any scheme for transmitting data over transitory media may be substituted with equal success for any of the foregoing tasks.

The communication subsystem of the capture device 1000 may include one or more data interfaces for removeable media. The capture device 1000 may read and write from a Secure Digital (SD) card or similar card memory.

While the foregoing discussion is presented in the context of SD cards, artisans of ordinary skill in the related arts will readily appreciate that other removeable media may be substituted with equal success (flash drives, MMC cards, etc.) Furthermore, the techniques described throughout may be applied with equal success to optical media (e.g., DVD, CD-ROM, etc.).

More generally, any scheme for storing data to non-transitory media may be substituted with equal success for any of the foregoing tasks.

Functionally, the control and data processing subsystems are used to read/write and store data to effectuate calculations and/or actuation of the sensor subsystem, user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 10, the control and data subsystem may include one or more of: a central processing unit (CPU 1006), an image signal processor (ISP 1002), a graphics processing unit (GPU 1004), a codec 1008, and a non-transitory computer-readable medium 1028 that stores program instructions and/or data. In some implementations, a neural network processing unit (NPU 1007) may additionally be included for machine-learning applications.

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU (such as shown in FIG. 6) may be primarily used to control device operation and/or perform tasks of arbitrary complexity/best-effort. CPU operations may include, without limitation: general-purpose operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or auto exposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization. In many cases, the ISP may locally execute its own real-time operating system (RTOS) to schedule tasks of according to real-time constraints.

Much like the ISP, the GPU is primarily used to modify image data and may be heavily pipelined (seldom branches) and may incorporate specialized vector-matrix logic. Unlike the ISP however, the GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance. In some cases, the GPU may locally execute its own operating system to schedule tasks according to its own scheduling constraints (pipelining, etc.).

The hardware codec converts image data to an encoded data for transfer and/or converts encoded data to image data for playback. Much like ISPs, hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). As with ISPs, codecs are often bottlenecked by network connectivity and/or processor bandwidth, thus codecs are seldom parallelized and may have specialized data structures (e.g., registers that are a multiple of an image row width, etc.). In some cases, the codec may locally execute its own operating system to schedule tasks according to its own scheduling constraints (bandwidth, real-time frame rates, etc.).

Other processor subsystem implementations may multiply, combine, further sub-divide, augment, and/or subsume the foregoing functionalities within these or other processing elements. For example, multiple ISPs may be used to service multiple camera sensors. Similarly, codec functionality may be subsumed with either GPU or CPU operation via software emulation.

In one embodiment, the memory subsystem may be used to store data locally at the capture device 1000. In one embodiment, data may be stored as non-transitory symbols (e.g., bits read from non-transitory computer-readable mediums.) In one specific implementation, the memory subsystem including non-transitory computer-readable medium 1028 is physically realized as one or more physical memory chips (e.g., NAND/NOR flash) that are logically separated into memory data structures. The memory subsystem may be bifurcated into program code 1030 and/or program data 1032. In some variants, program code and/or program data may be further organized for dedicated and/or collaborative use. For example, the GPU and CPU may share a common memory buffer to facilitate large transfers of data therebetween. Similarly, the codec may have a dedicated memory buffer to avoid resource contention.

In some embodiments, the program code may be statically stored within the capture device 1000 as firmware. In other embodiments, the program code may be dynamically stored (and changeable) via software updates. In some such variants, software may be subsequently updated by external parties and/or the user, based on various access permissions and procedures.

### Encoding a Dynamic Media Data Structure

While the following discussion is presented in the context of the capture device 1000 of FIG. 10, artisans of ordinary skill in the related arts will readily appreciate that the concepts described below may be broadly extended to any device that performs dynamic encoding locally (in-device). In-device dynamic encoding may have broadly applicability to a variety of other encoding applications e.g., streaming video content, 360° video, augmented reality/virtual reality and other hybrid realities, video conferencing, video editing and post-processing, surveillance systems, and any number of other media applications.

In one embodiment, the non-transitory computer-readable medium includes a routine that enables dynamic encoder configuration. When executed by the control and data subsystem, the routine causes the capture device to: convert data to media, dynamically select an encoder configuration, encode the media based on a dynamic encoder configuration, and write a dynamic media structure. The following discussion describes each step in more detail.

At step 1042, the capture device converts captured data to media. In one embodiment, the capture device includes a camera sensor that captures light information as data and converts the data to images and/or videos. More generally, any sensory modality may be captured and/or converted to media. For example, acoustic waveforms may be captured and converted to audio data. Similarly, velocity, and acceleration may be captured with inertial measurement sensors and converted to motion tracks, etc.

In other embodiments, media may be generated or otherwise created. For example, computer-generated graphics and/or computer-modeling may be used to generate video content. Generative artificial intelligence technologies have matured and can also generate a variety of different content (e.g., images, video, audio, etc.). Such techniques may be substituted with equal success by artisans of ordinary skill in the related arts.

Furthermore, while the foregoing examples are directed to devices that dynamically encode media at the time of capture, the concepts may be broadly extended to applications which dynamically encode media post-capture. For example, a archival video that was previously captured may be dynamically transcoded (e.g., decoded then dynamically encoded, etc.); the resulting dynamic media data structure may include both the dynamically transcoded media and the newly generated dynamic encoder configurations.

Here, “media” refers to data that may be edited, modified, spliced, rendered, replayed, and/or otherwise designed to be manipulated/consumed by a human. Typically, “media” refers to text, images, audio, video, and interactive content. Media may have associated metadata—this metadata describes the media. Dynamic media refers to media that is characterized by a time (or space) varying behavior. Similarly, dynamic metadata refers to metadata that is characterized by a time (or space) varying behavior. For example, video is a sequence of frames (images) which are played over time; a dynamic metadata track may provide information that varies as a function of the video's time reference. Dynamic metadata is distinguished from static metadata which does not vary over time; e.g., “title”, “artist”, etc.

At step 1044, the capture device dynamically selects an encoding configuration to encode the media. Here, “encoding” refers to apparatus and techniques that represent media within a structured data format; encoding is often used to optimize data for transmission, storage, rendering, presentation, and/or processing. For example, certain encodings may seek to reduce file size, reject data corruption, preserve signal fidelity, reduce latency, etc.

Encoding is performed with a codec that may be configured with an “encoding configuration” via an application programming interface (API). An API is a set of protocols that allows a software/firmware application to communicate with other entities. APIs may provide abstraction, interoperability, standardization, and/or security to software systems. Abstraction hides underlying machinations of the software application—this ensures distinct divisions in software architectures to prevent “bleed-through” of data between different processes. Interoperability and standardization enable different systems work together consistently and robustly. APIs may also provide various layers of security to avoid malicious actors, etc.

API-based configuration may be useful in mobile ecosystems that incorporate different devices of different capabilities. Generally, mobile ecosystems rely on mass-produced “commodity” codecs that are widely available and standardized. More generally, API-based codec configuration may be found in any system that uses “black box” and “white box” components. Here, “black box” refers to a system or component that hides its internal processes from other entities; only the inputs and outputs are observable. For example, a hardware encoder may hide its internals, thus presenting a “black box” to software. A “white box” refers to a system or component that exposes its internal machinations to other entities—in some cases, a white box may even allow direct manipulation of its data and/or processes.

Encoding configurations and other aspects of dynamic encoders are discussed in greater detail within U.S. application Ser. No. 18/701,256, filed Apr. 15, 2024, and entitled “METHODS AND APPARATUS FOR REAL-TIME GUIDED ENCODING”, and U.S. application Ser. No. 18/423,533, filed Jan. 26, 2024, and entitled “METHODS AND APPARATUS FOR DYNAMIC CODEC CONFIGURATION”, each of the foregoing previously incorporated by reference in their entireties.

While the foregoing discussions are presented in the context of an API-based encoding configuration, virtually any technique may be used to dynamically configure a codec to encode media. For example, direct access implementations may allow an external entity to directly access and/or adjust codec configuration. Other implementations may use a file-based scheme that provides codec configurations according to an alignment scheme (e.g., the file structure timestamp encoder configurations). Embedded and/or hardware based logic may be used to directly control encoder configuration, etc.

In one embodiment, selection is based on a user-specified configuration. As a practical matter, a user likely will not provide input at a dynamic rate (e.g., once every second, etc.), instead, a base user configuration may be used to inform logic that performs dynamic encoder control. In one such implementation, a user may select one or more “user-friendly” configurations (e.g., “maximum quality”, “instant share/network streaming”, “timelapse”, etc.) that are interpreted by dynamic encoder control logic to select the appropriate encoder configuration in real-time. In other embodiments, a user may identify the desired qualities and/or limitations (e.g., maximum bitrate, image quality PSNR (peak signal-to-noise ratio), etc.) which set the corresponding parameters of encoder configuration.

While the foregoing discussion is presented in the context of a camera user, the concepts may be more broadly expanded to other entities and/or applications. Human entities might include e.g., users, groups (such as audiences), and/or remote operators. For example, a smart phone may enable its user to transcode an existing video file, etc. In another such example, a camera might live stream vide to a number of humans, each of which might have different selection requirements. These selection requirements may be used to select/determine a number of encoding instances; in some cases, selections may be combined and/or cascaded to reduce the number of active encoding instances. Furthermore, multi-camera rigs are commonly used in certain special effects—in such implementations, the multi-camera rig may be coordinated by a single central point to ensure seamless transitions between camera angles, etc. Selection logic for a multi-camera rig may be propagated to all cameras of the rig in real-time to ensure that transitions between any of the camera views would be visually seamless.

Dynamic encoder configuration selection may be extended to computer-driven applications; in fact, computer entities may dynamically select encoder configurations based on their own requirements. For example, a generative AI application may dynamically generate video and its corresponding encoding parameters at real-time intervals. As another such example, remote camera operation may allow a server to provide encoder configurations, etc.

In some implementations, encoding configuration selection may additionally consider real-time guidance (e.g., quantization, compression, bit rate adjustment, and/or group of picture (GOP) sizing may be based on parameters provided from upstream image processing pipeline (IPP) operations). Real-time guidance can update and/or correct the encoding configuration during and (in some variants) throughout a live capture. For example, various stages of an IPP can use capture and conversion statistics and sensed motion data to configure the encoding parameters prior to image signal processing. In another such example, selection logic may use quantization parameters based on auto exposure and color space conversion statistics for the output images. In some cases, quantization parameters may be based on pixel motion vectors obtained from the temporal denoising. Where available, facial recognition, scene classification, and/or region-of-interest (ROI) metadata may also be used.

Real-time guidance may include ongoing encoding information. For example, encoder feedback may be used to determine GOP sizing. Similar adjustments may be made to compression and bit rate adjustments. The real-time guidance information from codec operation may be retrieved in advance of encoding—this is a function of the IPP's pipelining. More directly, instead of buffering 1 second of images within the codec so that the codec can perform look-forward/look-behind prediction, the selection logic may configure the codec's encoding parameters based on real-time guidance provided by earlier stages of the IPP.

While the foregoing discussion is presented in the context of an in-device image processing pipeline with a specific set of stages (e.g., an image signal processing stage, a stabilization and denoising stage, and an encoding stage) the concepts may be broadly applied to a variety of other processing pipelines. For example, some devices may incorporate communication stages (e.g., transmit/receive, encryption/decryption, etc.) for transmission over signaling media. Other devices may incorporate machine-learning, graphics processing, and/or other media manipulation stages. Yet other devices may include data analysis, filtering, and/or other monitoring stages. More generally, the encoder is just one processing element in a pipeline of processing elements. Each pipeline stage processes the data in sequence, and many issues that might affect encoding are also likely to affect pre-and-post-processing as well. Thus, the concepts may be broadly extended to any information from other processing stages that might be used to select encoder configuration.

At step 1046, the capture device dynamically encodes the media into encoded media segments based on an encoding configuration and writes a dynamic media data structure (step 1048).

Dynamic media may be encoded into data structure(s) according to its dynamic encoding configuration. In one embodiment, the encoding may be realized as “tracks” which may be aligned to one another (e.g., time-aligned, space-aligned, etc.). For example, a dynamic media data structure may include a dynamic media track (e.g., a video track and/or audio track, etc.) that may be aligned to a dynamic metadata track (e.g., image features, encoding features, etc.) according to a frame-by-frame basis or by group of pictures (GOP). In some cases, the encoding may be in a combined format (e.g., dual track, multi-track, etc.); alternatively, the encoding may be separated (e.g., a video data structure and a separate “sidecar” data structure—the sidecar may be aligned using timestamps, frame numbers, etc.).

More broadly, the encoded data structure may be extended to any data structure that allows for dynamic (varying) associations between the media information and its encoding considerations. The associations may be based on time, space, complexity, features and/or any other salient consideration. While the foregoing discussions are presented in the context of data structures that are recorded within non-transitory computer-readable media, the concepts may be broadly extended to transitory signals. For example, instead of writing to a file structure, the dynamic media may be streamed as signaling (e.g., wireless and/or wired signals).

The foregoing discussion has been framed in the context of a real-time operating system (RTOS) that schedules tasks for completion within definitive constraints. More generally however, the concepts may be broadly extended to high-level operating systems (OSes) which are typically best-effort. Notably, high-level OSes must dynamically manage varying task loads; in some cases, this may affect encoding quality. For example, a laptop running a low priority variable rate encoder may also have other applications running in the background. Under some conditions, the laptop may consider background memory usage when selecting encoder configuration since the encoding quality may be strongly affected by available memory resources. Other examples of processor-based selection criteria may include e.g., task load, memory load, memory availability, network bandwidth, power consumption, interrupt frequency, etc. More generally, selection heuristics may be broadly extended to any processing resource that might affect the encoded quality.

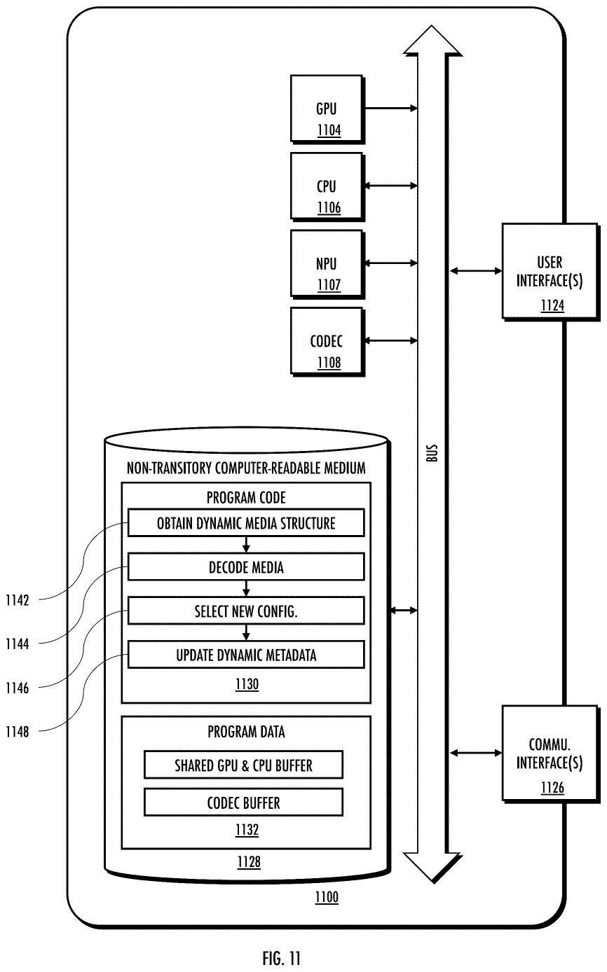

FIG. 11 is a logical block diagram of a post-capture processing device 1100. The post-capture processing device 1100 includes: a user interface subsystem, a communication subsystem, a control and data subsystem, and a bus to enable data transfer. The post-capture processing device 1100 has many similarities in operation and implementation to the capture device 1000 which are not further discussed below, the following discussion provides a discussion of the internal operations, design considerations, and/or alternatives, that are specific to post-capture processing device 1100 operation.

Functionally, the user interface subsystem 1124 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

Functionally, the communication subsystem 1126 may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) The data interfaces are configured to read/write data to a removeable non-transitory computer-readable medium (e.g., flash drive or similar memory media).

Functionally, the control and data processing subsystems are used to read/write and store data to effectuate calculations and/or actuation of the sensor subsystem, user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 11, the control and data subsystem may include one or more of: a central processing unit (CPU 1106), a graphics processing unit (GPU 1104), a codec 1108, and a non-transitory computer-readable medium 1128 that stores program instructions and/or data. In some implementations, a neural network processing unit (NPU 1107) may additionally be included for machine-learning applications.

In one embodiment, the memory subsystem may be used to store data locally at the post-capture processing device 1100. In one embodiment, data may be stored as non-transitory symbols (e.g., bits read from non-transitory computer-readable mediums.) In one specific implementation, the memory subsystem including non-transitory computer-readable medium 1128 is physically realized as one or more physical memory chips (e.g., NAND/NOR flash) that are logically separated into memory data structures. The memory subsystem may be bifurcated into program code 1130 and/or program data 1132. In some variants, program code and/or program data may be further organized for dedicated and/or collaborative use. For example, the GPU and CPU may share a common memory buffer to facilitate large transfers of data therebetween. Similarly, the codec may have a dedicated memory buffer to avoid resource contention.

In some embodiments, the program code may be statically stored within the post-capture processing device 1100 as firmware. In other embodiments, the program code may be dynamically stored (and changeable) via software updates. In some such variants, software may be subsequently updated by external parties and/or the user, based on various access permissions and procedures.

### Dynamic Transcoding

While the following discussion is presented in the context of the transcoding device 1100 of FIG. 11, artisans of ordinary skill in the related arts will readily appreciate that the concepts described below may be broadly extended to any device that performs dynamic post-capture processing of media. For example, post-capture processing may decode the media and dynamically present/render the media based on the dynamic encoder information.

In one embodiment, the non-transitory computer-readable medium includes a routine that enables dynamic transcoding. When executed by the control and data subsystem, the routine causes the transcoding device to: obtain a dynamic media data structure, decode encoded media, select a new configuration and encode the media based on the new configuration. In some variants, the updated dynamic media and/or dynamic metadata may be cumulatively updated to e.g., inform downstream post-processing.

At step 1142, the transcoding device obtains a dynamic media data structure. In one embodiment, the transcoding device obtains the dynamic media data by reading data from a non-transitory computer-readable media. In other embodiments, the transcoding device obtains the dynamic media data by receiving transitory computer-readable signals (e.g., wired and/or wireless communications). For example, a mobile ecosystem may use wireless communication e.g., a local area network, an ad hoc network, etc. to connect its various constituent devices.

In some embodiments, the dynamic media data may be received in its entirety. For example, a archival video may be retrieved in its entirety and dynamically transcoded at best-effort. In other embodiments the dynamic media data may be received as segments (or “chunks”). Chunk-based delivery may be associated with timing constraints (e.g., real-time or near real-time live streaming, etc.), sequence information, error checking codes (CRC), and/or mechanisms to ensure timely/robust delivery.

In other embodiments, media may be generated or otherwise created locally. As previously alluded to, computer-generated graphics, generative artificial intelligence, and/or computer-modeling may be used to generate video content. Such techniques may be substituted with equal success by artisans of ordinary skill in the related arts.

The dynamic media data may be obtained as “tracks” which may be aligned to one another (e.g., time-aligned, space-aligned, etc.). For example, a dynamic media data structure may include a dynamic media track (e.g., a video track and/or audio track, etc.) that may be aligned to a dynamic metadata track (e.g., image features, encoding features, etc.). In some cases, the dynamic media may be in a combined format (e.g., dual track, multi-track, etc.); alternatively, the dynamic media may be separated (e.g., a video data structure and a separate “sidecar” data structure—the sidecar may be aligned using timestamps, frame numbers, etc.).

Various other data structures may be substituted with equal success. Examples may include e.g., FIFO (first-in-first-out) circular buffers, last-in-first-out (LIFO), ping-pong buffers, stack (thread-specific), heap (thread-agnostic), and/or other memory organizations commonly used in the computing arts. More generally, however, any scheme for obtaining, providing, or otherwise transferring data may be substituted with equal success. Examples may include shared mailboxes, packet-based delivery, bus signaling, interrupt-based signaling, and/or any other mode of communication.

In transitory embodiments, the dynamic media data may be received as signaling which may be aligned to one another (e.g., time-aligned, space-aligned, etc.). For example, packets of dynamic media may be received with packets of dynamic metadata. In some cases, the packets may be sequenced and/or timestamped to enable re-sequencing. In other cases, the packets may be received and assembled as-is; for example, live streaming technologies often drop malformed packets since display artifacts (blocking, etc.) are less disruptive than playback sequence errors (freezing, etc.).

At step 1144, the transcoding device decodes encoded media based on the dynamic media data structure. In one embodiment, the encoded media is dynamically encoded media; in other embodiments, the encoded media is conventionally encoded; for example, a user may want to convert conventionally encoded media into dynamically encoded media, etc.

As a brief aside, most media formats require that the encode operation dictates decoder operation; this constraint is inherited from the aforementioned encode-once-deliver-often design paradigm of content delivery networks. However, artisans of ordinary skill in the related arts will readily appreciate that other systems might adopt other schemes. Systems where encode and decode have relative parity in importance may flip this dynamic e.g., decode requirements may direct the encoder to enable dynamic encoding that is optimized for decodes, etc. These schemes are becoming more prevalent as content delivery network capabilities outpace the consumer devices (which are often subject to more stringent industrial design considerations). For example, some streaming applications allow the decoder provide feedback to the encoder. As another such example, some decoders dynamically adjust their decode behavior based on e.g., network congestion, local resources, etc. In other words, while various aspects of the present disclosure are described in the context of dynamic encoding, artisans of ordinary skill in the related arts will readily appreciate that the concepts may be broadly extended to dynamic decoding as well.

In some embodiments, the decoded media includes, or may be aligned with, dynamic metadata that describes its content (e.g., image features, etc.), its capture, and/or its encoding (e.g., encoding features, etc.). The dynamic metadata may be associated with real-time (or near real-time) constraints for any downstream encoding device. As but one such example, an embedded device may have a fixed buffer size that limits the amount of data that can be captured (e.g., a camera may only have a 1 second memory buffer for image data)—this constraint on the decoded media may be leveraged by downstream encoders to appropriately allocate memory, etc.

As previously noted, real-time (and near real-time) processing is often subject to time-related constraints. In some embodiments, the dynamic media may include explicit timestamping or other messaging that directly associates it with corresponding dynamic metadata. This may be particularly useful for proxy data of arbitrary or unknown timing (e.g., user input or neural network classifications provided via a stack or heap type data structure, etc.).

In one embodiment, the dynamic metadata may include real-time (or near real-time) information generated by a sensor. Examples of such information may include light information, acoustic information, and/or inertial measurement data. In other embodiments, the real-time (or near real-time) metadata may be determined from onboard processing. For example, an image stabilization algorithm may generate motion vectors based on sensed inertial measurements. In other embodiments, an auto exposure, white balance, and color correction algorithms may be based on captured image data.

In one embodiment, the dynamic metadata may include real-time (or near realtime) information corresponding to a previous stage of the pipeline. For example, live streaming embodiments may encode video for transmission over a network; in some situations, the modem might provide network capacity information that identifies a bottleneck in data transfer capabilities (and by extension encoding complexity). As another example, computer vision applications (e.g., self-driving cars) may adjust encoding according to the application requirements, e.g., a neural network processor may provide proxy data based on object recognition from the image data, etc. As yet another example, a CPU might provide information from the OS on behalf of a user input received from the user interface.

More broadly, the dynamic metadata may include any real-time (or near real-time) information captured or generated by any upstream or downstream capture, feedback, processing, presentation, configuration, transcode, etc. While the foregoing discussion has been presented in the context of image processing pipeline data and codec encoding data, artisans of ordinary skill in the related arts will readily appreciate that other proxy data may come from the CPU, modem, neural network processors, and/or any other entity of the mobile ecosystem.

At step 1146, the transcoding device selects a new encoder configuration for at least a portion of the decoded media. Here, the encoder may operate on the dynamic media in whole or part. For example, only a portion of the decoded media may be of interest, or perhaps portions of the original encoding may be re-used without transcoding, etc.

In one embodiment, dynamic selection of the encoder configuration may be based on the dynamic metadata. Notably, dynamic selection may occur on a different time scale than the dynamic metadata—for example, dynamic metadata according to 1 second increments may support dynamic selection at (but not limited to) 1 second intervals. Dynamic selection may occur at a slower rate by ignoring, averaging, or otherwise interpolating across multiple dynamic metadata. Dynamic selection may occur at a faster rate by duplicating, padding, or otherwise interpolating between multiple dynamic metadata.

In some cases, dynamic selection logic may consider additional information from other pipeline stages and/or devices within the ecosystem. For example, the encoder configurations may be selected to meet the requirements of a downstream component, or accept the inputs from an upstream component, etc. Similarly, dynamic selection logic may consider rendering considerations (e.g., frame rate, resolution, bitrate, etc.) of the intended display, network socket, or other data sink.

In some variants, the dynamic metadata may be used to predict and/or estimate image complexity/encoder complexity for the new encode. In other words, the transcoding device may assume an image complexity based on the pixel features and encoding features of an image; the labeled image complexity may be used to e.g., select a bitrate that corresponds to an expected image quality. Here, the term “expected” refers to the outcome that is predicted, whereas “actual” refers to the outcome that is explicitly verified by an external process. More generally, the various principles described herein leverage the representative nature of the dynamic metadata to expected image quality to inform dynamic codec configuration, without requiring subsequent verification of the actual image quality.

In one embodiment, the expected image quality is based on an expected peak signal-to-noise ratio (PSNR) of pixel values for image quality, however other metrics may be substituted for image quality. Similarly, while the foregoing examples use bitrate selection as the configurable control parameter, other control parameters might be substituted with equal success. Examples might include minimum quantization parameter (QP), resolution, frame rate, bit depth, and/or other codec parameter(s) might be substituted with equal success.

More generally, dynamic selection logic may optimize for a variety of different parameters. Optimization targets might include e.g., local storage space, power consumption, network storage space, transmission size, and/or other resource. Different optimization targets may use different control parameters; generally, control parameters may affect e.g., complexity, latency, throughput, bit rate, media quality, data format, resolution, size, and/or any number of other media characteristics. More generally, any parameter that modifies the manner in which the transcoding is performed and/or the output of the transcoding process may be substituted with equal success.

In one embodiment, the dynamic selection logic may be determined in advance and retrieved from a look-up-table or similar reference data structure. In other embodiments, the dynamic selection logic may be calculated according to heuristics or algorithms. Still other embodiments may use e.g., machine learning algorithms or artificial intelligence logic to select suitable configurations. In some embodiments, external entities (e.g., a network or decoding device) may provide additional guidance, a selection of acceptable parameters that the transcoding device may select from, or even the encoding configurations themselves. More generally, however, any scheme for adjusting an encoding configurations based on dynamic metadata may be substituted with equal success.

In some variants, a transcoding device might consider the time averaged behavior to avoid resist sudden changes (avoiding “churn”). In other variants, an transcoding device might pre-emptively prepare for upcoming changes by e.g., adjusting encoder configuration in advance. In some cases, pre-emptive adjustments may additionally be propagated to downstream processing e.g., a change to encoder modality to accommodate an increase/decrease in anticipated bitrates may be propagated to downstream memory allocations and/or processing, etc.

At step 1148, the dynamic media data structure may be updated with the most recent dynamic metadata. As previously noted, the dynamic media data structure may be in a combined format (e.g., dual track, multi-track, etc.); alternatively, the encoding may be separated (e.g., a video data structure and a separate “sidecar” data structure—the sidecar may be aligned using timestamps, frame numbers, etc.

In some cases, the updated dynamic metadata overwrites the previous dynamic metadata. Overwriting dynamic metadata may allow for smaller file sizes, obscure/protect sensitive information, and/or prevent subsequent reversal. In other cases, the updated dynamic metadata is appended to the previous dynamic metadata. Appending or otherwise preserving a record of previous transcoding operations may be useful to reverse, or compensate for, the effects of cascaded transcoding.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant, or implementation. The appearances of such phrases in various places in the specification are not necessarily all referring to the same embodiment, variant, or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

As used herein, the terms “camera” or “image capture device” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
obtaining a dynamic media data structure comprising a plurality of encoder configurations that correspond to a plurality of encoded media; and
for at least a first time stamp of encoded media:
retrieving a first encoder configuration that corresponds to the first time stamp;
decoding a first encoded media that corresponds to the first time stamp into a first decoded media;
selecting a second encoder configuration that is different than the first encoder configuration; and
encoding the first decoded media based on the second encoder configuration into a second encoded media.

2. The method of claim 1, where the first encoder configuration comprises a first parameter characterized by a first heuristic, and the second encoder configuration comprises a second parameter characterized by a second heuristic.

3. The method of claim 2, further comprising selecting the second encoder configuration based on a mapping of the first heuristic to the second heuristic.

4. The method of claim 3, where the first parameter comprises a first bitrate, the first heuristic comprises a first bitrate-quality curve, the second parameter comprises a second bitrate, and the second heuristic comprises a second bitrate-quality curve.

5. The method of claim 1, where the first encoder configuration comprises at least one of a first bitrate, a first frame rate, a first bit depth, a first color space, or a first resolution, and the second encoder configuration comprises at least one of a second bitrate, a second frame rate, a second bit depth, a second color space, or a second resolution.

6. The method of claim 1, further comprising streaming the second encoded media over a network connection in real-time.

7. The method of claim 1, further comprising writing the second encoded media to an archival data structure.

8. An apparatus, comprising:
a camera sensor configured to capture light information;
a codec configured to dynamically encode the light information into a plurality of encoded media based on a plurality of encoder configurations;
a processor; and
a non-transitory computer-readable medium comprising instructions that, when executed by the processor, cause the apparatus to:
select a first encoder configuration at a first time;
encode a first light information into a first encoded media based on the first encoder configuration;
select a second encoder configuration at a second time;
encode a second light information into a second encoded media based on the second encoder configuration; and
generate a dynamic media data structure comprising the first encoder configuration and the second encoder configuration.

9. The apparatus of claim 8, further comprising a removable memory interface, and where the instructions further cause the processor to write the dynamic media data structure, the first encoded media, and the second encoded media, to a removeable memory via the removable memory interface.

10. The apparatus of claim 8, further comprising a network interface, and where the instructions further cause the processor to stream the dynamic media data structure, the first encoded media, and the second encoded media, via the network interface.

11. The apparatus of claim 8, further comprising a user interface, and where the instructions further cause the processor to render the first encoded media and the second encoded media based on the dynamic media data structure via the user interface.

12. The apparatus of claim 8, where a media track of the dynamic media data structure comprises the first encoded media and the second encoded media and a configuration track of the dynamic media data structure comprises the first encoder configuration and the second encoder configuration.

13. The apparatus of claim 8, where the first encoder configuration comprises a first parameter characterized by a first heuristic, and the second encoder configuration comprises a second parameter characterized by a second heuristic.

14. The apparatus of claim 8, where the first encoder configuration comprises at least one of a first bitrate, a first frame rate, a first bit depth, a first color space, or a first resolution, and the second encoder configuration comprises at least one of a second bitrate, a second frame rate, a second bit depth, a second color space, or a second resolution.

15. An apparatus, comprising:
a codec configured to dynamically transcode a plurality of encoded media chunks based on a plurality of encoder configurations;
a processor;
a non-transitory computer-readable medium comprising instructions that, when executed by the processor, cause the apparatus to:
for each encoded media chunk of a dynamic media data structure:
obtain an original encoded media chunk and an original encoder configuration;
decode the original encoded media chunk based on the original encoder configuration to obtain an original media chunk;
select a new encoder configuration; and
encode the original media chunk into a new encoded media chunk based on the new encoder configuration.

16. The apparatus of claim 15, where the instructions further cause the apparatus to overwrite the original encoded media chunk with the new encoded media chunk.

17. The apparatus of claim 15, where the instructions further cause the apparatus to append the new encoder configuration to the original encoder configuration.

18. The apparatus of claim 15, where the instructions further cause the apparatus to overwrite the original encoder configuration with the new encoder configuration.

19. The apparatus of claim 15, where the dynamic media data structure associates the plurality of encoded media chunks to the plurality of encoder configurations based on a plurality of timestamps.

20. The apparatus of claim 15, further comprising a network interface configured to receive or transmit the plurality of encoded media chunks and the plurality of encoder configurations according to a real-time budget.
